(19) United States
(12) Patent Application Publication
(10) Pub. No.: US 2013/0021669 A1
(43) Pub. Date: Jan. 24, 2013

(54) Spectrally Tunable Optical Filter

(71) Applicants: Jingqun Xi, Cambridge, MA (US); Frank W. Mont, Troy, NY (US)

(72) Inventors: Jingqun Xi, Cambridge, MA (US); Frank W. Mont, Troy, NY (US)

(73) Assignee: RAYDEX TECHNOLOGY, INC., Cambridge, MA (US)

(21) Appl. No.: 13/188,120

(22) Filed: Jul. 21, 2011

(51) Int. Cl. G02B 26/00

(52) U.S. Cl. 359/578

(57) ABSTRACT

There is herein described an optical filter. The optical filter includes a substrate and a plurality of at least four optical thin film layers. The optical thin film layers are disposed on top of the substrate. Each of the optical thin film layers has an effective refractive index different from effective refractive indices of the immediate upper and lower optical thin film layers. At least one of the optical thin film layers is a thickness tunable nano-feature layer. The nano-feature layer contains a plurality of flexible nano-features. At least one of the optical thin film layers is a dense layer.

### TECHNICAL FIELD

This invention relates to an optical filter. In particular, this invention relates to a spectrally tunable optical filter having an adjustable thickness.

### BACKGROUND

Spectrally tunable optical filters are widely used in optical systems, such as optical imaging system, optical communications systems, and lighting devices. In the past decades, a great number of different spectrally tunable filter techniques have been proposed and developed.

Mode-coupling tunable filter is one type of spectrally tunable optical filter, which is constructed using acousto-optic, electro-optic or magneto-optic effects. The mode-coupling tunable filter typically has a bandwidth of less than 1 nanometer (nm) and a tuning range of larger than 100 nanometers (nm). However, such tunable filters require specific optical materials, which is usually very costly. Grating tunable filter is another type of spectrally tunable optical filter, which uses diffraction effects to realize the wavelength separation and selection. The grating tunable filter typically contains a grooved grating to utilize grating diffraction effects. The grating tunable filter can provide a narrow bandwidth with accuracy, and a long tuning range. However, the grating tunable filter usually requires mechanical rotation of the grating to realize the wavelength selection, which leads to disadvantages such as bulk volume and slow tuning speed.

Another popular type of the spectrally tunable filters is the liquid crystal tunable filter. The liquid crystal filter realizes the tunable optical thickness by utilizing a liquid crystal layer, which has tunable refractive index. However, the liquid crystal layer can only achieve a small refractive index change. Thus, the tunable range of the optical thickness enabled by the refractive index change is small.

Some Microelectromechanical system (MEMS) tunable filters use adjustable air-gaps to achieve the tunability. However, the size of such a MEMS tunable filter is small due to the technical difficulties to fabricate air-gap with a large area. Typically, the feasible area of the air-gap is below 50×50 μm². Furthermore, the fabrication process of MEMS limits the fabrication of tunable filter with a sophisticated layer structure involving air-gaps, which increases the cost and complexity of the fabrication.

### SUMMARY

It is an object of the invention to obviate the disadvantages of the prior art.

It is a further object of the invention to provide a spectrally tunable optical filter device that has a large spectral tunable range.

According to an embodiment, there is provided an optical filter. The optical filter includes a substrate and a plurality of at least four optical thin film layers. The optical thin film layers are disposed on top of the substrate. Each of the optical thin film layers has an effective refractive index different from effective refractive indices of the immediate upper and lower optical thin film layers. At least one of the optical thin film layers is a thickness tunable nano-feature layer. The nano-feature layer contains a plurality of flexible nano-features. At least one of the optical thin film layers is a dense layer.

According to some related embodiments, the top layer of the plurality of the optical thin film layer may be a dense layer. The plurality of optical thin film layers may be a plurality of optical thin film pairs. Each pair of the optical thin film pairs may include a low-index optical thin film layer and a high-index optical thin film layer. The high-index optical thin film layer of each pair of the optical thin film pairs may have an effective refractive index higher than an effective refractive index of the low-index optical thin film layer of the same pair. The optical filter may have a targeting wavelength and each of the optical thin film layers may have an optical thickness substantially close to a quarter of the targeting wavelength. The nano-feature layer may have a space and the space may be filled with at least one material selected from the group consisting of air, gas, liquid, water, optical fluid, transparent fluid, opaque fluid, semi-transparent fluid, diffusive fluid, organic solution, elastic host material, polymer resin, gel, and silicone. The space may be in vacuum.

The flexible nano-features may be core-shell nano-features. The flexible nano-features may comprise nano-rods, nano-tubes, nano-belts, nano-springs, nano-wires, nano-columns, nano-spirals, zigzag-shaped chains of nano-rods, or a combination thereof. The nano-features and dense layers may comprise materials such as, but not limited to, SiO₂, SiO, TiO₂, MgF₂, Al₂O₃, BaF₂, CaF₂, Si, Si₃N₄, GaN, AlN, InN, AlGaN, GaInN, ITO, SnO₂, In₂O₃, TiNbO, ZnO, Ge, GaAs, AlAs, AlGaAs, ZnSe, PMMA, acrylic glass or a combination thereof. The optical filter may further comprise a means for changing the thickness of the optical filter, such as, but not limited to, piezoelectric actuator, mechanical piston, MEMS actuator, electrical motor, pneumatic actuator, hydraulic actuator, linear actuator, comb-drives capacitive actuator, amplified piezoelectric actuator, thermal bimorph, micromirror device, electroactive polymer, electromagnetic actuator, magnet, magnetic mesh, magnetic film, conductive flim, metal mesh, metal film, transparent electrode, transparent semiconductor film, transparent conductive oxide film, indium tin oxide film, laser optical pump, light-emitting diode optical pump, tungsten lamp optical pump, discharge lamp optical pump, heat pump, thermal cooling device, pressure port, or a combination thereof. The nano-features may have a spacing-to-width ratio larger than 1:2, preferably larger than 1:1, more preferably larger than 2:1. The nano-features may have a length-to-width ratio larger than 3:1, preferably larger than 6:1, more preferably larger than 10:1. The porosity of the nano-feature layers may be at least 50%, preferably at least 70%, and even more preferably at least 90%. The nano-feature layers may have a thin film area larger than 50×50 μm², preferably 100×100 μm², more preferably 500×500 μm².

According to another embodiment, there is provided an optical filter. The optical filter includes a substrate, a plurality of first optical thin film layers, a thickness tunable layer and a plurality of second optical thin film. The first optical thin film layers are disposed on top of the substrate. The thickness tunable layer is disposed on top of the first optical thin film layers. The thickness tunable layer includes at least one first nano-feature layer. The first nano-feature layer contains a plurality of flexible nano-features. The second optical thin film layers are disposed on the thickness tunable layer. At least one of the second optical thin film layers is a dense layer.

According to some related embodiments, the top layer of the second optical thin film layers may be a dense layer. The thickness tunable layer further may include a second nano-feature layer disposed on top of the first nano-feature layer and the second nano-feature layer may contain a plurality of flexible nano-features. The thickness tunable layer further may include a third nano-feature layer disposed on top of the second nano-feature layer and the third nano-feature layer may contain a plurality of flexible nano-features. The thickness tunable layer may further include a first dense layer and a second nano-feature layer. The first dense layer may be disposed on top of the first nano-feature layer. The second nano-feature layer may be disposed on top of the first dense layer and the second nano-feature layer may contain a plurality of flexible nano-features. The thickness tunable layer may further include a second dense layer and a third nano-feature layer. The second dense layer may be disposed on top of the second nano-feature layer. The third nano-feature layer may be disposed on top of the second dense layer and the third nano-feature layer may contain a plurality of flexible nano-features. The plurality of the first optical thin film layers may be a plurality of optical thin film pairs. Each pair of the optical thin film pairs may include a low-index optical thin film layer and a high-index optical thin film layer. The high-index optical thin film layer of each pair of the optical thin film pairs may have an effective refractive index higher than an effective refractive index of the low-index optical thin film layer of the same pair. At least one of the first optical thin film layers may have a reflective surface. At least one of the second optical thin film layers may have a reflective surface.

The optical filter according to the invention is capable of changing its thickness by bending, deforming, compressing, or stretching the nano-features reversibly. Thus, the optical filter may have a large tuning range, for example, but not limited to, 100 nm to several microns. It is possible to manufacture such an optical filter having a thickness at the nano-scale or micro-scale, for example, but not limited to, 100 nm-20 μm. The optical filter may have an optical area larger than 50×50 μm². The optical filter may maintain its spectral tunability in vacuum, in air environment, in gas environment, in liquid environment, or in elastic host material environment.

### BRIEF DESCRIPTION OF THE DRAWINGS

The foregoing and other objects, features and advantages disclosed herein will be apparent from the following description of particular embodiments disclosed herein, as illustrated in the accompanying drawings in which like reference characters refer to the same parts throughout the different views. The drawings are not necessarily to scale, emphasis instead being placed upon illustrating the principles disclosed herein.

FIG. 1A is a schematic illustration of an optical filter according to an embodiment of the invention.

FIG. 1B is a schematic illustration of an optical filter according to the embodiment of FIG. 1A, in a compressed status.

FIG. 2A is a schematic illustration of an optical filter according to another embodiment of the invention.

FIG. 2B is a schematic illustration of an optical filter according to the embodiment of FIG. 2A, in a compressed status.

FIG. 3A is a schematic illustration of an optical filter according to another embodiment of the invention.

FIG. 3B is a schematic illustration of an optical filter according to the embodiment of FIG. 3A, in a compressed status.

FIG. 4A is a schematic illustration of an optical filter according to another embodiment of the invention.

FIG. 4B is a schematic illustration of an optical filter according to the embodiment of FIG. 4A, in a compressed status.

FIG. 5A is a schematic illustration of an optical filter according to another embodiment of the invention.

FIG. 5B is a schematic illustration of an optical filter according to the embodiment of FIG. 5A, in a compressed status.

FIG. 6A is a schematic illustration of an optical filter according to another embodiment of the invention.

FIG. 6B is a schematic illustration of an optical filter according to the embodiment of FIG. 6A, in a compressed status.

FIG. 7A is a schematic illustration of an optical filter according to another embodiment of the invention.

FIG. 7B is a schematic illustration of an optical filter according to the embodiment of FIG. 7A, in a compressed status.

FIG. 8A is a schematic illustration of an optical filter according to another embodiment of the invention.

FIG. 8B is a schematic illustration of an optical filter according to the embodiment of FIG. 8A, in a compressed status.

FIG. 9A is a schematic illustration of an optical filter according to another embodiment of the invention.

FIG. 9B is a schematic illustration of an optical filter according to the embodiment of FIG. 9A, in a compressed status.

FIG. 10A is a schematic illustration of an optical filter according to another embodiment of the invention.

FIG. 10B is a schematic illustration of an optical filter according to the embodiment of FIG. 10A, in a compressed status.

FIG. 11A is a schematic illustration of an optical filter according to another embodiment of the invention.

FIG. 11B is a schematic illustration of an optical filter according to the embodiment of FIG. 11A, in a compressed status.

FIG. 12A is a schematic illustration of an optical filter according to another embodiment of the invention.

FIG. 12B is a schematic illustration of an optical filter according to the embodiment of FIG. 12A, in a compressed status.

FIG. 13A is a schematic illustration of an optical filter according to another embodiment of the invention.

FIG. 13B is a schematic illustration of an optical filter according to the embodiment of FIG. 13A, in a compressed status.

FIG. 14A is a schematic illustration of an optical filter according to another embodiment of the invention.

FIG. 14B is a schematic illustration of an optical filter according to the embodiment of FIG. 14A, in a compressed status.

FIG. 15A is a schematic illustration of an optical filter according to another embodiment of the invention.

FIG. 15B is a schematic illustration of an optical filter according to the embodiment of FIG. 15A, in a stretched status.

FIG. 16A is a schematic illustration of an optical filter according to another embodiment of the invention.

FIG. 16B is a schematic illustration of an optical filter according to the embodiment of FIG. 16A, in a stretched status.

FIG. 17A is a schematic illustration of an optical filter according to another embodiment of the invention.

FIG. 17B is a schematic illustration of an optical filter according to the embodiment of FIG. 17A, in a stretched status.

FIG. 18A is a schematic illustration of an optical filter according to another embodiment of the invention.

FIG. 18B is a schematic illustration of an optical filter according to the embodiment of FIG. 18A, in a stretched status.

FIG. 19A is a schematic illustration of an optical filter according to another embodiment of the invention.

FIG. 19B is a schematic illustration of an optical filter according to the embodiment of FIG. 19A, in a compressed status.

FIG. 20A is a schematic illustration of an optical filter according to another embodiment of the invention.

FIG. 20B is a schematic illustration of an optical filter according to the embodiment of FIG. 20A, in a compressed status.

### DETAILED DESCRIPTION

For a better understanding of the present invention, together with other and further objects, advantages and capabilities thereof, reference is made to the following disclosure and appended claims taken in conjunction with the above-described drawings.

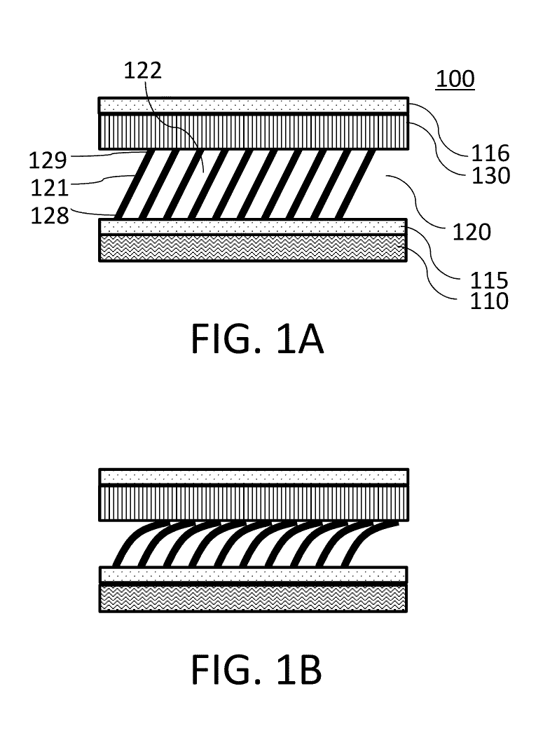

With reference to FIG. 1A, an optical filter 100, in accordance with an embodiment of the invention is shown. The optical filter 100 includes a substrate 110. The material of substrate 110 is preferably transparent in the spectrum of interest. However, the substrate may also be reflective, opaque, diffusive, or semi-transparent. The material of the substrate can be any optical material, such as, but not limited to, SiO₂, SiO, TiO₂, MgF₂, Al₂O₃, BaF₂, CaF₂, Si, Si₃N₄, GaN, AlN, InN, AlGaN, GaInN, ITO, SnO₂, In₂O₃, TiNbO, ZnO, Ge, GaAs, AlAs, AlGaAs, ZnSe, PMMA, acrylic glass or a combination thereof. The substrate may have one or more optical coatings 115 on top. The optical coatings may be alternating layers of optical thin films. One example of alternating layers of optical thin films is that the first layer of optical coatings 115 contains SiO₂, and the second layer contains TiO₂; if there is a third layer, the third layer contains SiO₂; if there is a fourth layer, the fourth layer contains TiO₂; and so on. Another example of alternating layers of optical thin films is that the first layer of optical coatings 115 contains TiO₂, and the second layer contains SiO₂; if there is a third layer, the third layer contains TiO₂; if there is a fourth layer, the fourth layer contains SiO₂; and so on. A thickness tunable nano-feature layer 120 may be deposited on top of the optical coatings 115. Thickness tunable nano-feature layer 120 contains a plurality of flexible nano-features 121. Flexible nano-features 121 may be nano-rods. The spacing-to-width ratio of nano-features 121 may be preferably 1:2, more preferably 1:1, even more preferably 2:1. A spacing-to-width ratio of a plurality of nano-features is defined as the ratio between the average spacing between the neighboring nano-features and the average wire width of the nano-features. The length-to-width ratio of nano-features 121 may be preferably 3:1, more preferably 6:1, even more preferably 10:1. A length-to-width ratio of a plurality of nano-features is defined as the ratio of the average wire length and the average wire width of the nano-features. Nano-features 121 may be deposited, grown, etched, or formed using techniques such as, but not limited to, sputtering, thermal evaporation, electron-beam evaporation, physical vapor deposition, oblique angle deposition, aqueous chemical growth, aqueous solution, non-aqueous solution, electrochemical deposition, sol-gel, laser ablation, chemical vapor deposition, chemical vapor transport, molecular-beam epitaxy, hydride vapor epitaxy, vapor-liquid-solid growth, vapor-solid growth, metal catalyst growth, catalyst growth, catalyst-free synthesis, thermal annealing, thermal growth, template-assisted growth, lithographic techniques, nano-lithography, self-assembly, wet-chemical etching, dry etching, reactive-ion etching, inductively-coupled plasma etching, or a combination thereof. The resulting porosity of nano-feature layer 120 is at least 50%, preferably at least 70%, and even more preferably more than 90%. A porosity of a nano-feature layer is defined as the ratio of the volume of the space between nano-features to the entire volume of the nano-feature layer. The nano-features are flexible so that the nano-features are able to be bent, deformed, compressed, or stretched reversibly. The resulting thickness tunable nano-feature layer 120 may achieve a reversible thickness variation via a reversible structural deformation of the flexible nano-features. Since the feature size of nano-features 121 is at nanoscale, the scattering effect at the near ultraviolet, visible, and infrared spectra may be minimized. One or more dense layers 130 may be deposited on top of nano-feature layer 120, using techniques such as, but not limited to, sputtering, thermal evaporation, electron-beam evaporation, physical vapor deposition, oblique angle deposition, aqueous chemical growth, aqueous solution, non-aqueous solution, electrochemical deposition, sol-gel, laser ablation, chemical vapor deposition, chemical vapor transport, molecular-beam epitaxy, hydride vapor epitaxy, vapor-liquid-solid growth, vapor-solid growth, metal catalyst growth, catalyst growth, catalyst-free synthesis, thermal annealing, thermal growth, template-assisted growth, lithographic techniques, nano-lithography, self-assembly, and electrochemical deposition. The term “dense layer” refers to a layer having substantially low porosity less than 30%. Preferably, the porosity of the dense layer may be less than 20%; even more preferably, the porosity of the dense layer may be less than 10%. The top nano-feature layer needs to be capped using dense layers 130 to serve as strong mechanical layers to apply the force to bend or deform all the nano-features uniformly. These dense layers can also serve as optical coatings in the device. Each of nano-features 121 has a top end 129 and a bottom end 128. Nano-features typically have two ends; the bottom end is closer to the substrate than the top end. The top ends 129 are substantially in close contact of dense layer 130. The bottom ends 128 may be substantially in close contact of substrate 110 or substantially in close contact of the optical coatings 115. Nano-features 121 may be deposited, grown, etched, or formed on top of substrate 110 or on top of the optical coatings 115. The materials selection for the nano-feature layers and capping dense layer deposition, can be any optical material, such as, but not limited to, SiO₂, SiO, TiO₂, MgF₂, Al₂O₃, BaF₂, CaF₂, Si, Si₃N₄, GaN, AlN, InN, AlGaN, GaInN, ITO, SnO₂, In₂O₃, TiNbO, ZnO, Ge, GaAs, AlAs, AlGaAs, ZnSe, PMMA, acrylic glass or a combination thereof. The nano-feature may contain multiple materials mixed together. The nano-features may be core-shell nano-features where the material of the outside portion of nano-features is different from the inside portion of the nano-features. The deposition techniques of nano-features enable thin film nano-feature layers having optical areas larger than 50×50 μm², preferably larger than 100×100 μm², more preferably 500×500 μm².

Flexible nano-features 121 in the nano-feature layer 120 have a superior mechanical elasticity due to the high spacing-to-width ratio and length-to-width ratio. When an external force is exercised on top of dense layer 130 toward optical filter 100, nano-features 121 may be bent, deformed, compressed, or stretched reversibly due to the mechanical elasticity, as shown in FIG. 1B. Such deformation of nano-features 121 may reduce the thickness of nano-feature layer 120. As a result, the thickness of the optical filter 100 becomes less, while the porosity of nano-feature layer 120 becomes less accordingly. Thus, the thickness of optical filter 100 changes accordingly, and the spectral tunability of the optical filter 100 can be achieved. When the external pressure is released or nano-feature layer 120 is stretched by another external force, nano-features 121 may recover to the original shape and the thickness of optical filter 100 may reverse back to its original value. When an even larger external pressure is released or nano-feature layer 120 is stretched further by another larger external force, nano-features 121 may be stretched larger than the original shape and the thickness of optical filter 100 may be larger than its original value. The length-to-width ratio is preferred to be relatively high because nano-features having a low length-to-width ratio will require unreasonably high pressure to bend, deform, compress, or stretch the nano-features and are susceptible to irreversible structural deformation.

Assuming a linear relationship between the refractive index and the porosity, the refractive index of a nano-feature layer, which is comprised nano-feature such as, such as nano-rods, nano-tubes, nano-belts, nano-springs, nano-wires, nano-columns, or nano-spirals, can be determined by the following equation:

n=n_{dense}×(1−φ)+1×φ (1)

wherein n_{dense} is the refractive index of the dense layer comprised of same material with 0% porosity; and φ is the porosity of the layer.

For example, SiO₂(n=1.46) nano-rod layer with an 80% porosity has a refractive index of 1.092. If those nano-rods are compressed by 50% in terms of height, the thickness of the compressed nano-rod thin film layer will be half of the original, un-compressed thickness, h′=½ h. The porosity of the compressed SiO₂ nano-rod thin film layer will be 60%, which yields a refractive index of 1.184. As a result, the thickness of the compressed nano-rod layer is about 54% compared to the one of original nano-rod thin film layer before the compression. This large thickness change may enable a spectral response shift by substantially the same percentage in terms of wavelength. Further compression or stretching may enable even a larger thickness change for spectral tunability.

Thin film nano-feature layers may include different nano-features, such as, but not limited to, nano-rods, nano-tubes, nano-belts, nano-columns, nano-wires, nano-springs, nano-spirals, or a combination thereof.

Optical filter 100 including nano-feature layer 120 may work in different environments. Nano-feature layer 120 has a high porosity, which means that there is space 122 between the nano-features 121. Space 122 may be in vacuum. Space 122 may be filled with air or gas. Nano-feature layer 120 is still capable of bending, deforming, compressing, or stretching reversibly when space 122 is filled with liquid such as water, optical fluid, transparent fluid, opaque fluid, semi-transparent fluid, diffusive fluid, or organic solution. Furthermore, nano-feature layer 120 is capable of bending, deforming, compressing, or stretching reversibly when space 122 is filled with elastic host materials such as polymer resin, gel, silicone, or any deformable material. Therefore, optical filter 100 maintains its spectral tunability in various environments such as in vacuum, in ambient air, in gas, in liquid, or in elastic host materials.

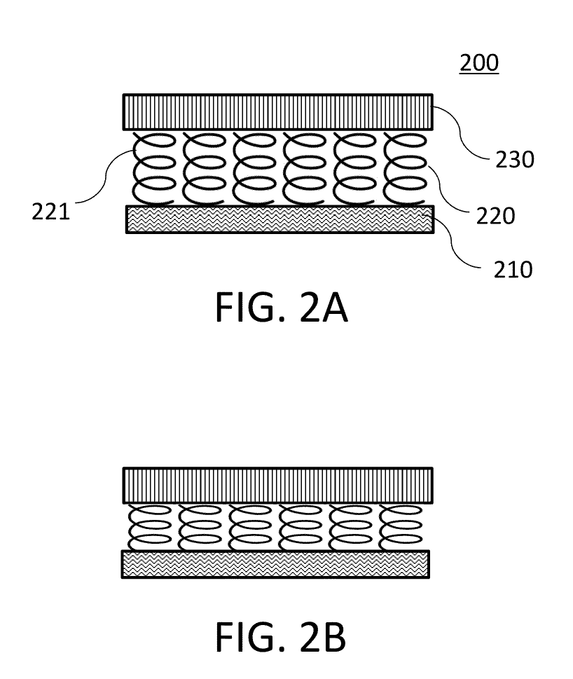

In another embodiment, an optical filter 200 may include a substrate 210, a nano-feature layer 220, and a dense layer 230. Nano-feature layer 220 includes a plurality of nano-springs 221 as shown in FIG. 2A. The spacing-to-width ratio of nano-feature 220 may be preferably 1:2, more preferably 1:1, even more preferably 2:1. A spacing-to-width ratio of a plurality of nano-features is defined as the ratio between the average spacing between the neighboring nano-features and the average wire width of the nano-features. For nano-springs, the average wire width is the average diameter of the nano-wires being coiled to create the nano-springs. The length-to-width ratio of nano-feature layer 220 may be preferably 3:1, more preferably 6:1, even more preferably 10:1. A length-to-width ratio of a plurality of nano-features is defined as the ratio of the average wire length and the average wire width of the nano-features. For nano-springs, the average wire length is the average overall length of the nano-wires being coiled to create the nano-springs. The resulting porosity of nano-feature layer 220 is at least 50%, preferably at least 70%, and even more preferably at least 90%. The nano-features are flexible so that nano-feature layer 220 contains nano-springs 221 may be compressed or stretched reversibly to various thicknesses in order to achieve the spectral tunability, as shown in FIG. 2B.

Different nano-features in different materials may be chosen to fabricate the nano-feature thin film layer as a part of tunable optical filter targeting for different spectrum range. The nano-features fabricated in the layer may be, but not limited to, nano-rods, nano-tubes, nano-belts, nano-columns, nano-wires, nano-springs, nano-spirals, or a combination thereof. For visible and near infrared spectra, the materials of the nano-features may be, but not limited to, SiO₂, SiO, BaF₂, CaF₂, MgF₂, CaF₂, TiO₂, Al₂O₃, Si₃N₄, GaN, AlN, AlGaN, GaInN, ITO, SnO₂, In₂O₃, TiNbO, ZnO, PMMA, acrylic glass or a combination thereof. For infrared spectra, the materials of the nano-features may be, but not limited to, InN, Ge, GaAs, AlAs, AlGaAs, BaF₂, CaF₂, MgF₂, Si, ZnSe, Si, or a combination thereof.

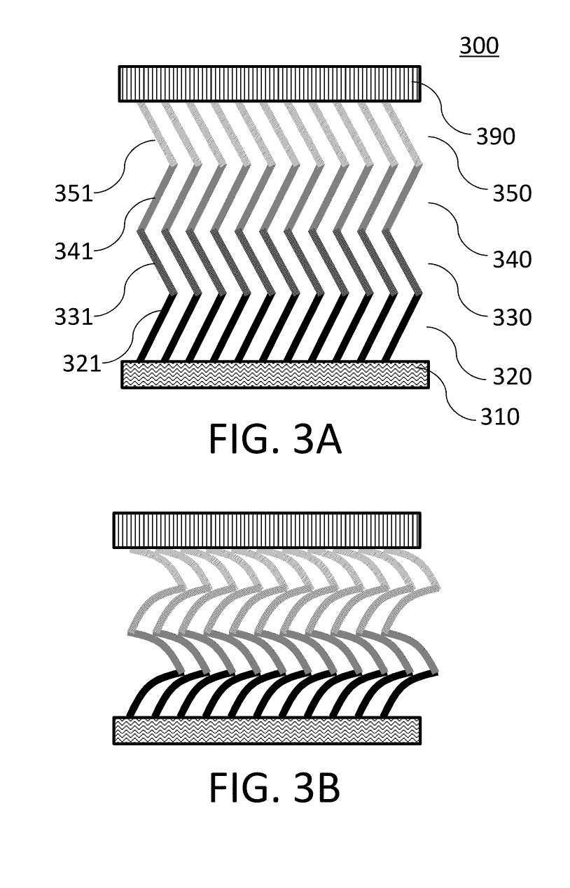

In an embodiment as illustrated in FIG. 3A, optical filter 300 may be fabricated using a stack of nano-rod thin film layers 320, 330, 340 and 350 on top of substrate 310. Nano-rod layers may be deposited using vapor deposition techniques, such as e-beam evaporation, sputtering deposition, or combination thereof. Nano-rod layer 320 may be deposited on substrate 310 using oblique angle deposition with a tilted substrate 310. After the first nano-rod layer 320 being deposited, substrate 310 is rotated to another tilting angle for the deposition of second nano-rod layer 330. The tilting angle of substrate 310 is selected so that the second nano-rod layer 330's nano-rods 331 can be deposited on the top of the first nano-rod layer 320's nano-rods 321 and form the zigzag-shaped chains of nano-rods. After the second nano-rod layer 330 being deposited, substrate 310 is rotated to yet another tilting angle for the deposition of third nano-rod layer 340. The tilting angle of the substrate 310 is selected so that the third nano-rod layer 340's nano-rods 341 can be deposited on the top of the second nano-rod layer's nano-rods 331 and form the zigzag-shaped chains of nano-rods. The fourth nano-rod layer 350's nano-rods 351 can be deposited on the top of the third nano-rod layer's nano-rods 341 and form the zigzag-shaped chains of nano-rods. This deposition process may continue as needed to stack more nano-rod layers on top of the sample and to form an optical filter 300 consisting of multiple nano-rod layers, as shown in FIG. 3A. On the top of the nano-rod layers, a capping dense layer 390 may be deposited to close the openings between the nano-rods. Dense layer 390 may be deposited using the vapor deposition techniques with substrate 310 being at normal direction, or one or more layers is deposited with substrate at small tilting angle, followed by the deposition at normal substrate orientation. Different nano-rod layers may contain different materials. The materials selection for the nano-rod layers and capping dense layer deposition, can be any optical material, such as, but not limited to, SiO₂, SiO, TiO₂, MgF₂, Al₂O₃, BaF₂, CaF₂, Si, Si₃N₄, GaN, AlN, InN, AlGaN, GaInN, ITO, SnO₂, In₂O₃, TiNbO, ZnO, Ge, GaAs, AlAs, AlGaAs, ZnSe, PMMA, acrylic glass or a combination thereof. The spacing-to-width ratio of the nano-feature layers may be preferably 1:2, more preferably 1:1, even more preferably 2:1. The length-to-width ratio of the nano-feature layers may be preferably 3:1, more preferably 6:1, even more preferably 10:1. The resulting porosity of the nano-feature layer is at least 50%, preferably at least 70%, and even more preferably at least 90%. The optical characteristics of optical filter 300 are determined by the refractive indices and the thickness of the nano-rod thin film layers. The multiple layers of chained nano-features may change their thicknesses due to an external force, as shown in FIG. 3B. Accordingly, the optical filter 300's thickness and porosity may change by compressing or stretching the stack of nano-feature thin film layers. Therefore, such an optical filter 300 has a spectral tunability due to the thickness tunability.

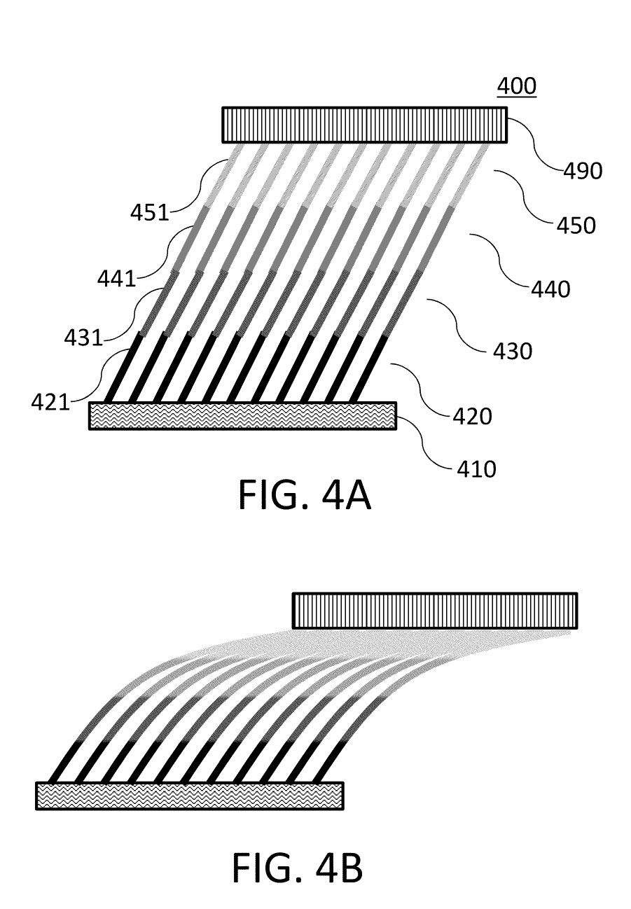

As illustrated in FIG. 4A, another embodiment of spectrally tunable optical filter 400 consisting of a plurality of nano-rod layers is shown. Nano-rod layers 420, 430, 440 and 450 are deposited on top of substrate 410 using vapor deposition techniques, such as e-beam evaporation, sputtering deposition, or a combination thereof. Nano-rod layer 420 is deposited on substrate 410 using oblique angle deposition with a tilted substrate 410. After the first nano-rod layer 420 being deposited, substrate 410 is kept to the same tilting angle, or has no significant substrate tiling angle change, for the deposition of second nano-rod layer 430. The substantially same tilting angle of substrate 410, i.e. no significant substrate tiling angle change, ensures that the nano-rods 431 of the second layer 430 can grow almost at the same orientation as the nano-rods 421 of the first layer 420 beneath it, as shown in FIG. 4A. After the second nano-rod layer 430 being deposited, substrate 410 is kept to the same tilting angle, or has no significant substrate tiling angle change, for the deposition of third nano-rod layer 440. The substantially same tilting angle of substrate 410, i.e. no significant substrate tiling angle change, ensures that the nano-rods 441 of the third layer 440 can grow almost at the same orientation as the nano-rods 421, 431 of the first and second layers 420, 430 beneath it, as shown in FIG. 4A. The similar process can be continued to deposit more nano-rod layers as needed. On the top of the nano-rod layers, a capping dense layer 490 may be deposited to close the openings between the nano-rods. Such dense layer 490 may be deposited using the vapor deposition techniques with substrate 410 being at normal direction, or one or more layers is deposited with substrate at small tilting angle, followed by the deposition at normal substrate orientation. Different nano-rod layers may contain different materials. The materials selection for the nano-rod layers and capping dense layer deposition, can be any optical material, such as, but not limited to, SiO₂, SiO, TiO₂, MgF₂, Al₂O₃, BaF₂, CaF₂, Si, Si₃N₄, GaN, AlN, InN, AlInN, AlGaN, GaInN, ITO, SnO₂, In₂O₃, TiNbO, ZnO, Ge, GaAs, AlAs, AlGaAs, ZnSe, PMMA, acrylic glass, or a combination thereof. The spacing-to-width ratio of the nano-feature layers may be preferably 1:2, more preferably 1:1, even more preferably 2:1. The length-to-width ratio of the nano-feature layers may be preferably 3:1, more preferably 6:1, even more preferably 10:1. The resulting porosity of the nano-feature layers is at least 50%, preferably at least 70%, and even more preferably at least 90%. The multiple layers of chained nano-features may change their thicknesses due to an external force, as shown in FIG. 4B. Therefore, such an optical filter 400 is a spectrally tunable by changing the thickness.

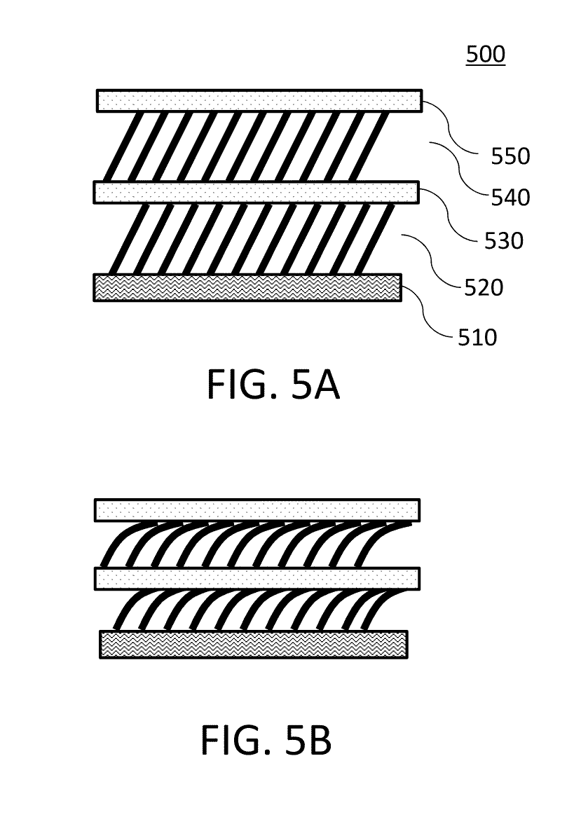

Yet another embodiment is shown in FIG. 5A. Optical filter 500 contains a nano-rod layer 520 deposited on substrate 510 using oblique angle deposition with a tilted substrate 510. After the first nano-rod layer 520 being deposited, substrate 510 is rotated to normal orientation or another specific tilting angle for depositing dense layer 530 on top of nano-rod layer 520. Nano-rod layer 540 is deposited on top of dense layer 530. Dense layer 550 is deposited on top of nano-rod layer 540. Additional nano-rod layers and dense layers may be further deposited according the procedure described above to stack the nano-feature layers and dense layers. The layers may be deposited using vapor deposition techniques, such as e-beam evaporation, sputtering deposition, or a combination thereof. Different nano-rod layers and dense layers may contain different materials. The materials selection for the nano-rod layers and dense layers deposition, can be any optical material, such as, but not limited to, SiO₂, SiO, TiO₂, MgF₂, Al₂O₃, BaF₂, CaF₂, Si, Si₃N₄, GaN, AlN, InN, AlGaN, GaInN, ITO, SnO₂, In₂O₃, TiNbO, ZnO, Ge, GaAs, AlAs, AlGaAs, ZnSe, PMMA, acrylic glass or a combination thereof. The spacing-to-width ratio of each of the nano-feature layers may be preferably 1:2, more preferably 1:1, even more preferably 2:1. The length-to-width ratio of each of the nano-feature layers may be preferably 3:1, more preferably 6:1, even more preferably 10:1. The resulting porosity of each of the nano-feature layers is at least 50%, preferably at least 70%, and even more preferably at least 90%. The multiple layers of nano-features may change their thicknesses due to an external force, as shown in FIG. 5B. Therefore, such an optical filter 500 is a spectrally tunable by changing the thickness.

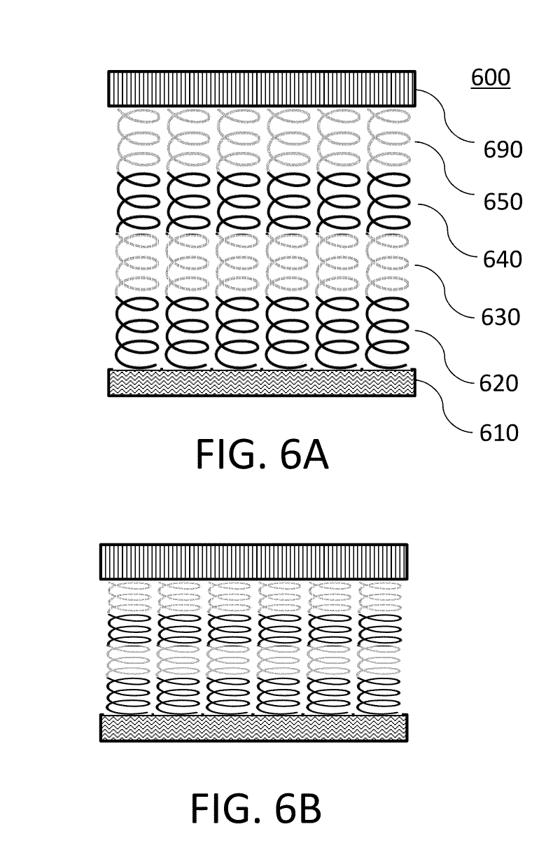

In an embodiment as illustrated in FIG. 6A, optical filter 600 may be fabricated using a stack of nano-spring thin film layers 620, 630, 640 and 650 on top of substrate 610. Nano-rod layers may be deposited using vapor deposition techniques, such as e-beam evaporation, sputtering deposition, or combination thereof. Nano-spring layer 620 may be deposited on substrate 610 using oblique angle deposition with a tilted spinning substrate 610. After the first nano-spring layer 620 being deposited, substrate 610 is kept to the same tilting angle, or rotated to a different tilting angle for the deposition of second nano-spring layer 630. After the second nano-spring layer 630 being deposited, substrate 610 is kept to the same tilting angle, or rotated to a different tilting angle for the deposition of third nano-rod layer 640. This deposition process may continue as needed to stack more nano-spring layers on top of the sample and to form an optical filter 600 consisting of multiple nano-spring layers, as shown in FIG. 6A. On the top of the nano-spring layers, a capping dense layer 690 may be deposited to close the openings between the nano-springs. Dense layer 690 may be deposited using the vapor deposition techniques with substrate 610 being at normal direction, or one or more layers is deposited with substrate at small tilting angle, followed by the deposition at normal substrate orientation. Different nano-rod layers may contain different materials. The materials selection for the nano-spring layers and capping dense layer deposition, can be any optical material, such as, but not limited to, SiO₂, SiO, TiO₂, MgF₂, Al₂O₃, BaF₂, CaF₂, Si, Si₃N₄, GaN, AlN, InN, AlGaN, GaInN, ITO, SnO₂, In₂O₃, TiNbO, ZnO, Ge, GaAs, AlAs, AlGaAs, ZnSe, PMMA, acrylic glass or a combination thereof. The spacing-to-width ratio of the nano-feature layers may be preferably 1:2, more preferably 1:1, even more preferably 2:1. The length-to-width ratio of the nano-feature layers may be preferably 3:1, more preferably 6:1, even more preferably 10:1. The resulting porosity of the nano-feature layer is at least 50%, preferably at least 70%, and even more preferably at least 90%. The multiple layers of nano-features may change their thicknesses due to an external force, as shown in FIG. 6B. Therefore, such an optical filter 600 is a spectrally tunable by changing the thickness.

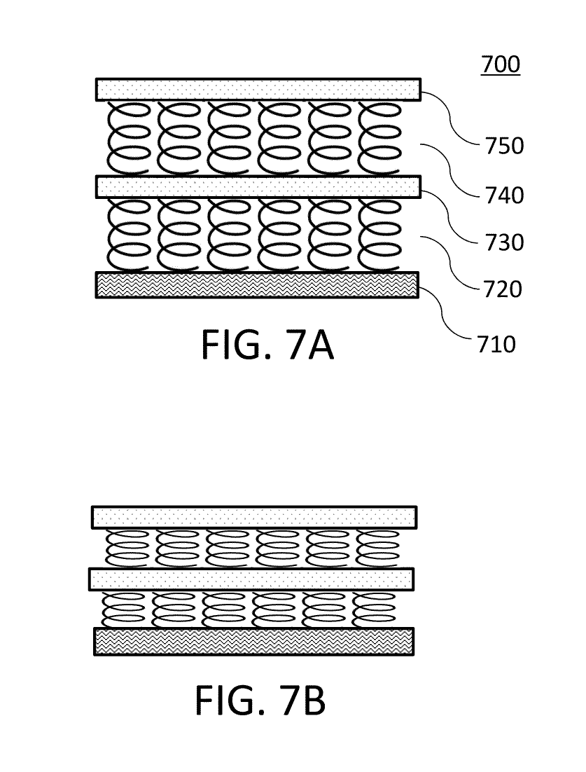

Another embodiment is shown in FIG. 7A. Optical filter 700 contains a nano-spring layer 720 deposited on substrate 710 using oblique angle deposition with a tilted spinning substrate 710. After the first nano-spring layer 720 being deposited, substrate 710 is rotated to normal orientation or another specific tilting angle for depositing dense layer 730 on top of nano-spring layer 720. Nano-spring layer 740 is deposited on top of dense layer 730. Dense layer 750 is deposited on top of nano-spring layer 740. Additional nano-spring layers and dense layers may be further deposited according to the procedure described above to stack the nano-feature layers and dense layers. The layers may be deposited using vapor deposition techniques, such as e-beam evaporation, sputtering deposition, or a combination thereof. Different nano-spring layers and dense layers may contain different materials. The materials selection for the nano-spring layers and dense layers deposition, can be any optical material, such as, but not limited to, SiO₂, SiO, TiO₂, MgF₂, Al₂O₃, BaF₂, CaF₂, Si, Si₃N₄, GaN, AlN, InN, AlGaN, GaInN, ITO, SnO₂, In₂O₃, TiNbO, ZnO, Ge, GaAs, AlAs, AlGaAs, ZnSe, PMMA, acrylic glass or a combination thereof. The spacing-to-width ratio of each of the nano-feature layers may be preferably 1:2, more preferably 1:1, even more preferably 2:1. The length-to-width ratio of each of the nano-feature layers may be preferably 3:1, more preferably 6:1, even more preferably 10:1. The resulting porosity of each of the nano-feature layers is at least 50%, preferably at least 70%, and even more preferably at least 90%. The multiple layers of nano-features may change their thicknesses due to an external force, as shown in FIG. 7B. Therefore, such an optical filter 700 is a spectrally tunable by changing the thickness.

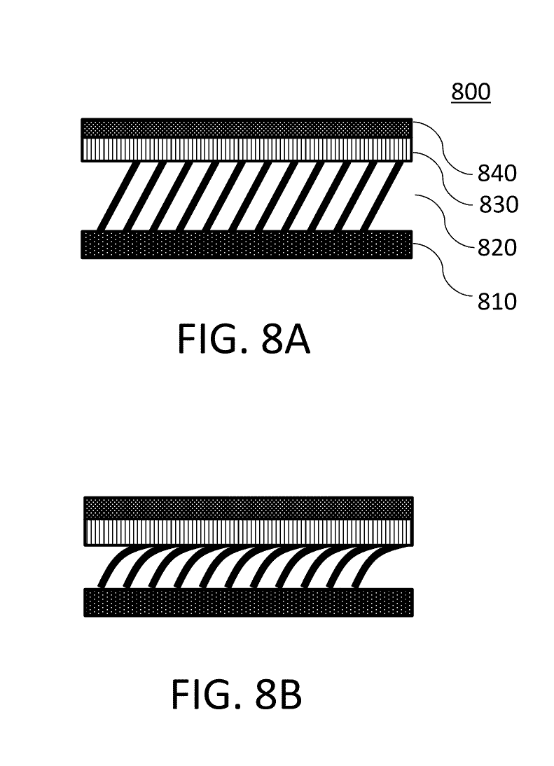

In another embodiment as illustrated in FIG. 8A, an optical filter 800 may include two reflection layers 810, 840, a nano-rod layer 820, and a dense layer 830. Reflection layers 810, 840 may contain highly reflective surface, such as metal surface or distributed Bragg reflector. Nano-rod layer 820 may be deposited on reflection layer 810 with a tilted orientation using oblique angle deposition techniques. The nano-rods 821 of layer 820 may be deposited using vapor deposition techniques, such as e-beam evaporation, sputtering deposition, or a combination thereof. More nano-rod layers may be deposited using the similar process as needed. On top of the nano-rod layer 820, a capping dense layer 830 may be deposited to close the openings between the nano-rods. Dense layer 830 may be deposited using the vapor deposition techniques with substrate at normal direction, or one or more layers is deposited with substrate at small tilting angle, followed by the deposition at normal substrate orientation. On top of dense layer 830, another reflection layer 840 may be deposited to finish the thin film stack fabrication of optical filter 800. The materials selection for the nano-rod layer and dense layer deposition, can be any optical material, such as, but not limited to, SiO₂, SiO, TiO₂, MgF₂, Al₂O₃, BaF₂, CaF₂, Si, Si₃N₄, GaN, AlN, InN, AlGaN, GaInN, ITO, SnO₂, In₂O₃, TiNbO, ZnO, Ge, GaAs, AlAs, AlGaAs, ZnSe, PMMA, acrylic glass or a combination thereof. The spacing-to-width ratio of the nano-feature layer may be preferably 1:2, more preferably 1:1, even more preferably 2:1. The length-to-width ratio of the nano-feature layer may be preferably 3:1, more preferably 6:1, even more preferably 10:1. The resulting porosity of the nano-feature layer is at least 50%, preferably at least 70%, and even more preferably at least 90%. The nano-feature layer may change the thickness due to an external force, as shown in FIG. 8B. Therefore, such an optical filter 800 is a spectrally tunable by changing the thickness. Two reflection layers 810, 840 can bounce the optical ray back and forth to cause interference effect. A band-pass filter can be realized by such structure. The thickness change of the middle nano-feature layer 820 enable the thickness change of the middle layer, and hence enable the spectral tunability of such band-pass filter.

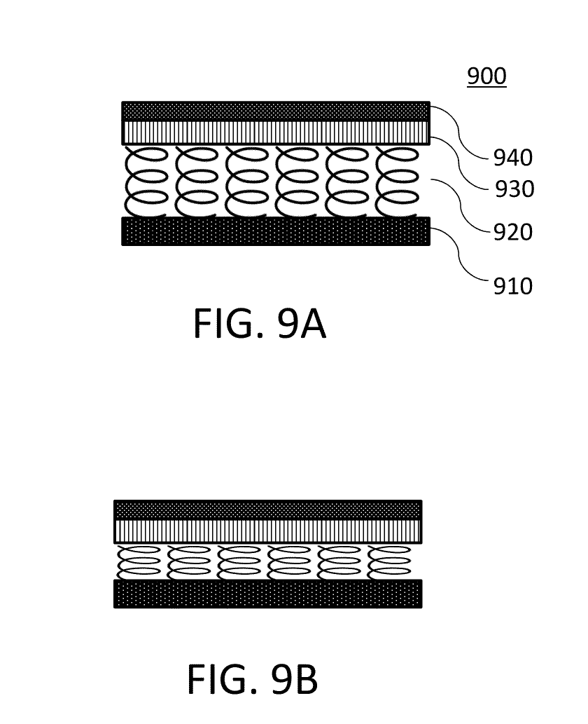

In another embodiment as illustrated in FIG. 9A, an optical filter 900 may include two reflection layers 910, 940, a nano-spring layer 920, and a dense layer 930. Reflection layers 910, 940 may contain highly reflective surface, such as metal surface or distributed Bragg reflector. Nano-spring layer 920 may be deposited on reflection layer 910 with a tilted orientation with spinning using oblique angle deposition techniques. The nano-springs 921 of layer 920 may be deposited using vapor deposition techniques, such as e-beam evaporation, sputtering deposition, or a combination thereof. More nano-spring layers may be deposited using the similar process as needed. On top of the nano-spring layer 920, a capping dense layer 930 may be deposited to close the openings between the nano-springs. Dense layer 930 may be deposited using the vapor deposition techniques with substrate at normal direction, or one or more layers is deposited with substrate at small tilting angle, followed by the deposition at normal substrate orientation. On top of dense layer 930, another reflection layer 940 may be deposited to finish the thin film stack fabrication of optical filter 900. The materials selection for the nano-spring layer and dense layer deposition, can be any optical material, such as, but not limited to, SiO₂, SiO, TiO₂, MgF₂, Al₂O₃, BaF₂, CaF₂, Si, Si₃N₄, GaN, AlN, InN, AlGaN, GaInN, ITO, SnO₂, In₂O₃, TiNbO, ZnO, Ge, GaAs, AlAs, AlGaAs, ZnSe, PMMA, acrylic glass or a combination thereof. The spacing-to-width ratio of the nano-feature layer may be preferably 1:2, more preferably 1:1, even more preferably 2:1. The length-to-width ratio of the nano-feature layer may be preferably 3:1, more preferably 6:1, even more preferably 10:1. The resulting porosity of the nano-feature layer is at least 50%, preferably at least 70%, and even more preferably at least 90%. The nano-feature layer may change the thickness due to an external force, as shown in FIG. 9B. Therefore, such an optical filter 900 is a spectrally tunable by changing the thickness.

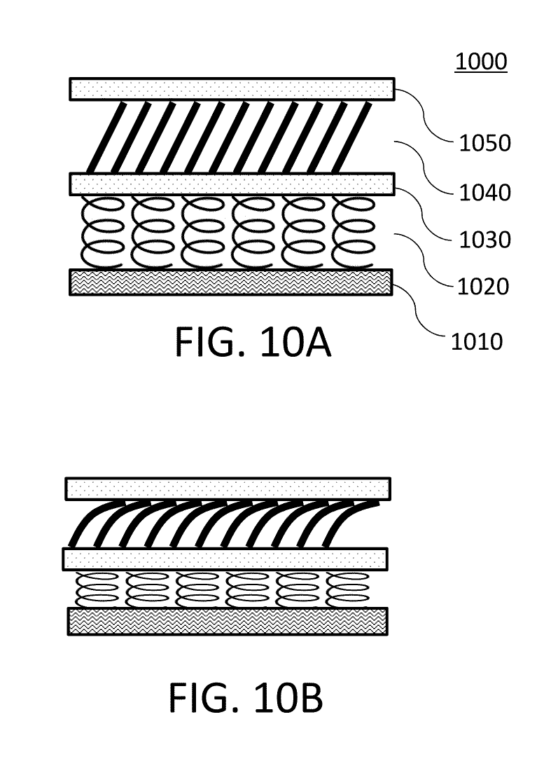

Another embodiment is shown in FIG. 10A. Optical filter 1000 includes a nano-spring layer 1020 deposited on substrate 1010 using oblique angle deposition with a tilted spinning substrate 1010. After the first nano-spring layer 1020 being deposited, substrate 1010 is rotated to normal orientation or another specific tilting angle for depositing dense layer 1030 on top of nano-spring layer 1020. Nano-rod layer 1040 is deposited on top of dense layer 1030. Dense layer 1050 is deposited on top of nano-rod layer 1040. Additional nano-spring layers, nano-rod layers, and dense layers may be further deposited according the procedure described above to stack the nano-feature layers and dense layers. The layers may be deposited using vapor deposition techniques, such as e-beam evaporation, sputtering deposition, or a combination thereof. Different nano-feature layers and dense layers may contain different materials. The materials selection for the nano-feature layers and dense layers deposition, can be any optical material, such as, but not limited to, SiO₂, SiO, TiO₂, MgF₂, Al₂O₃, BaF₂, CaF₂, Si, Si₃N₄, GaN, AlN, InN, AlGaN, GaInN, ITO, SnO₂, In₂O₃, TiNbO, ZnO, Ge, GaAs, AlAs, AlGaAs, ZnSe, PMMA, acrylic glass or a combination thereof. The spacing-to-width ratio of each of the nano-feature layers may be preferably 1:2, more preferably 1:1, even more preferably 2:1. The length-to-width ratio of each of the nano-feature layers may be preferably 3:1, more preferably 6:1, even more preferably 10:1. The resulting porosity of each of the nano-feature layers is at least 50%, preferably at least 70%, and even more preferably at least 90%. The multiple layers of nano-features may change their thicknesses due to an external force, as shown in FIG. 10B. Therefore, such an optical filter 1000 is a spectrally tunable by changing the thickness.

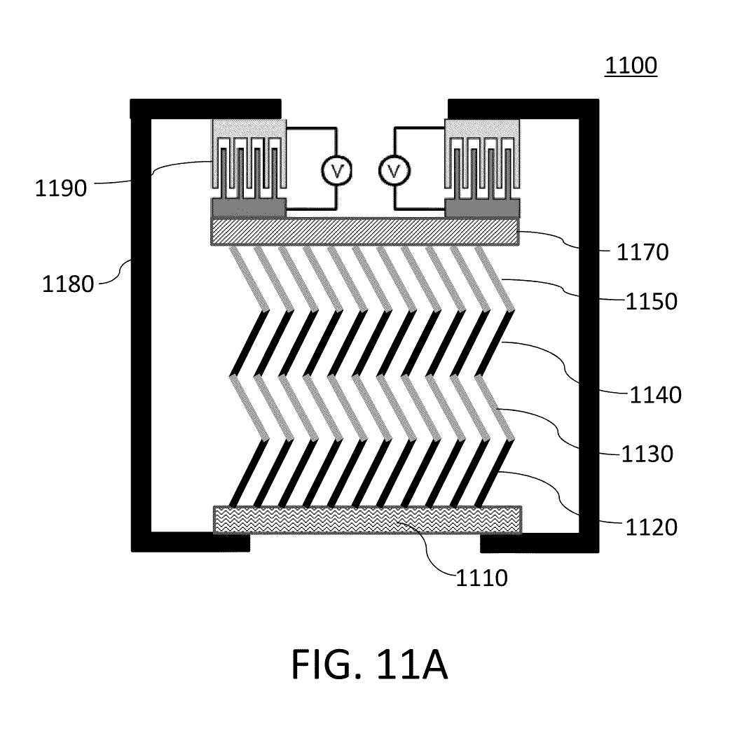

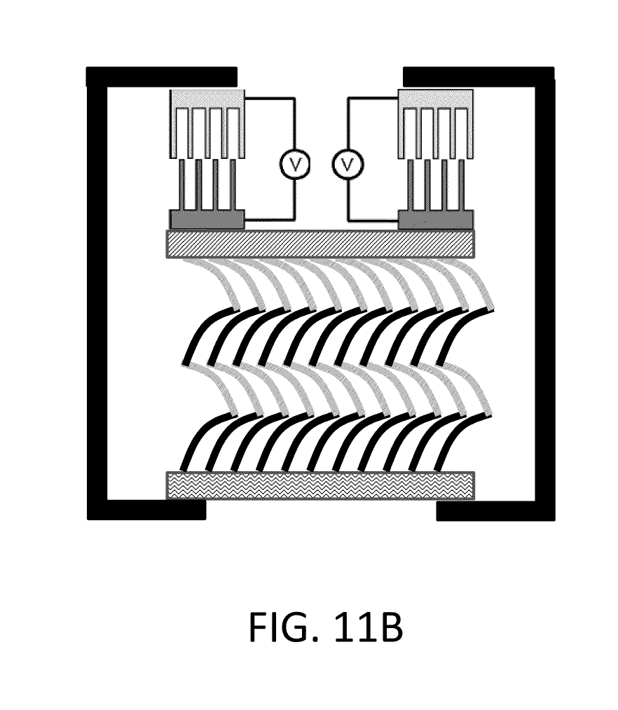

In another embodiment as illustrated in FIG. 11A, an optical filter 1100 may include one or more actuators 1190. Optical filter 1100 may include nano-rod layers 1120, 1130, 1140 and 1150 being deposited on substrate 1110 using oblique angle deposition. Nano-rod layers 1120, 1130, 1140 and 1150 are deposited to form zigzag-shaped chains of nano-rods. On the top of the nano-rod layers, a capping dense layer 1170 may be deposited to close the openings between the nano-rods. Dense layer 1170 may be optically transparent and may serve as an optical window or as part of the optical filter. Dense layer 1170 may be directly deposited on top of the nano-rod layers using vapor deposition techniques or may be attached to the top of the nano-rods layers using adhesives. The structure including substrate 1110, nano-rod layers 1120, 1130, 1140, 1150, and dense layer 1170 may be mounted into a solid frame 1180, as shown in FIG. 11A. A means to apply force such as actuators may be utilized to compress or stretch the layers. Actuators 1190 may be mounted between dense layer 1170 and solid frame 1180 to finish the packaging of optical filter 1100. Actuators 1190 may be, but not limited to, piezoelectric actuators, mechanical pistons, MEMS actuators, electrical motors, pneumatic actuators, hydraulic actuators, linear actuators, comb-drives capacitive actuators, amplified piezoelectric actuators, thermal bimorphs, micromirror devices, electroactive polymers, electromagnetic actuators, or a combination thereof. The controllable thickness change of the nano-feature layers such as nano-rod layers 1120, 1130, 1140 and 1150, hence and the spectral tunability of opical filter 1100, can be achieved by controlling the actuators' movement. Different nano-rod layers may contain different materials. The materials selection for the nano-rod layers and dense layer deposition, can be any optical material, such as, but not limited to, SiO₂, SiO, TiO₂, MgF₂, Al₂O₃, BaF₂, CaF₂, Si, Si₃N₄, GaN, AlN, InN, AlGaN, GaInN, ITO, SnO₂, In₂O₃, TiNbO, ZnO, Ge, GaAs, AlAs, AlGaAs, ZnSe, PMMA, acrylic glass or a combination thereof. The spacing-to-width ratio of the nano-feature layers may be preferably 1:2, more preferably 1:1, even more preferably 2:1. The length-to-width ratio of the nano-feature layers may be preferably 3:1, more preferably 6:1, even more preferably 10:1. The resulting porosity of the nano-feature layer is at least 50%, preferably at least 70%, and even more preferably at least 90%. Actuators 1190 may apply force to change the nano-feature layers' thicknesses reversibly, as shown in FIG. 11B. Therefore, such an optical filter 1100 is spectrally tunable by changing the thickness.

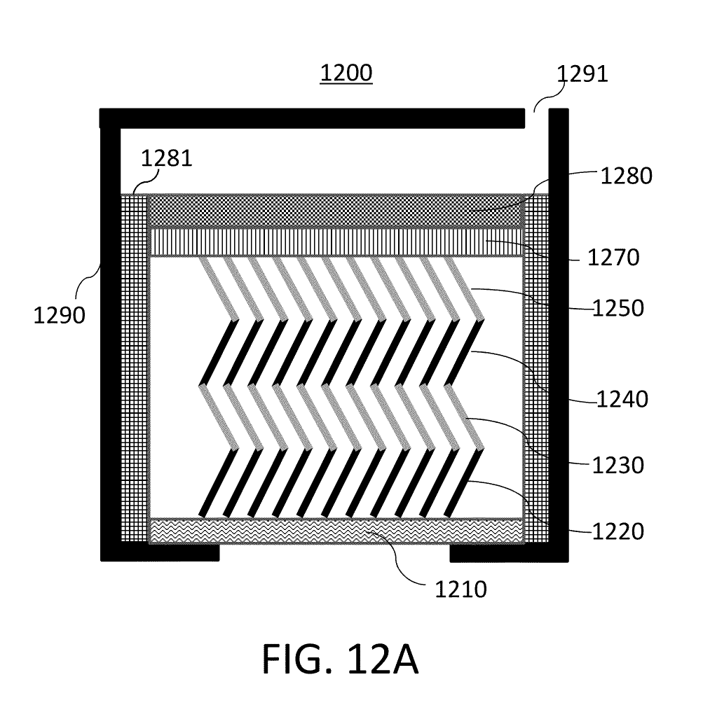

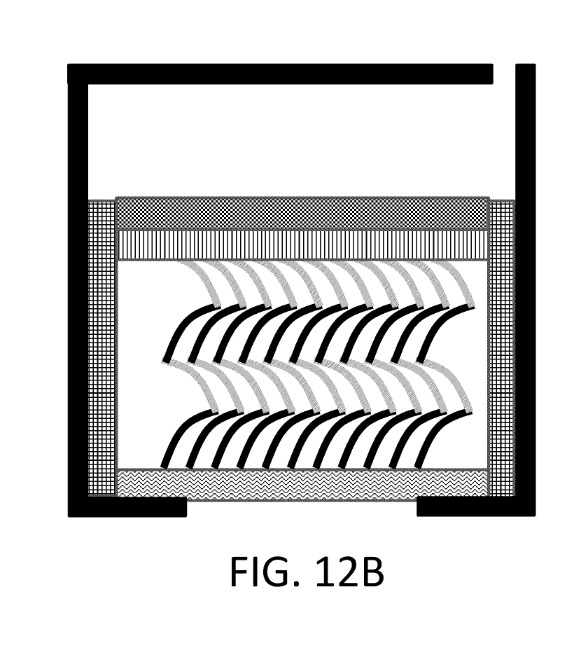

In yet another embodiment as illustrated in FIG. 12A, an optical filter 1200 may include substrate 1210, nano-rod layers 1220, 1230, 1240, 1250, dense layer 1270, being arranged in a similar way as the embodiment of FIG. 11A, and a pressure port 1291. A dense sealing layer 1280 seals the top surface of dense layer 1270. Dense sealing layer 1280 may be, but not limited to, a thin film by vapor deposition, a plastic sheet, a glass sheet, silicone, or a combination thereof. Sealant 1281 seals the sides of a multilayer stack which comprises substrate 1210, nano-rod layers 1220, 1230, 1240, 1250, dense layer 1270 and dense sealing layer 1280. The whole sealed multilayer stack is disposed inside a sealed container 1290. Sealed container 1290 has the pressure port 1291 for pressure control. By controlling the pressure inside sealed container 1290 through pressure port 1291, the multilayer stack may be compressed or stretched accordingly to change the thicknesses of the nano-rod layers 1220, 1230, 1240 and 1250, as shown in FIG. 12B. Hence, optical filter 1200 achieves the optical tunability by varying the thicknesses of the nano-feature layers.

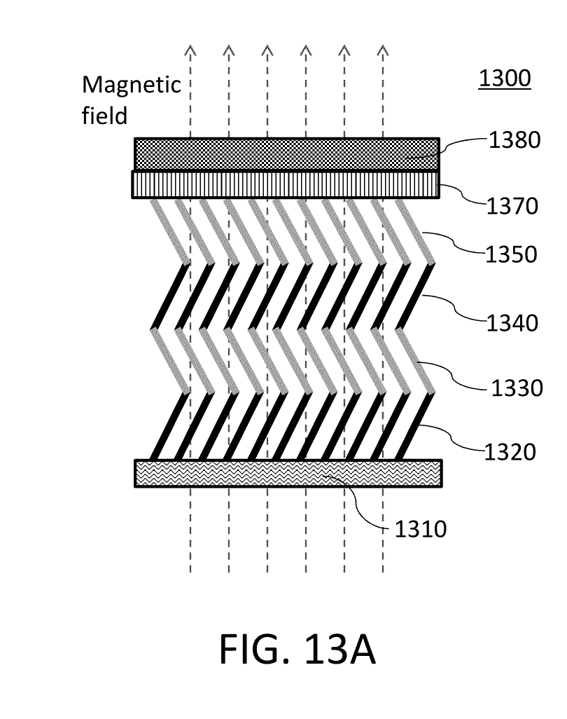

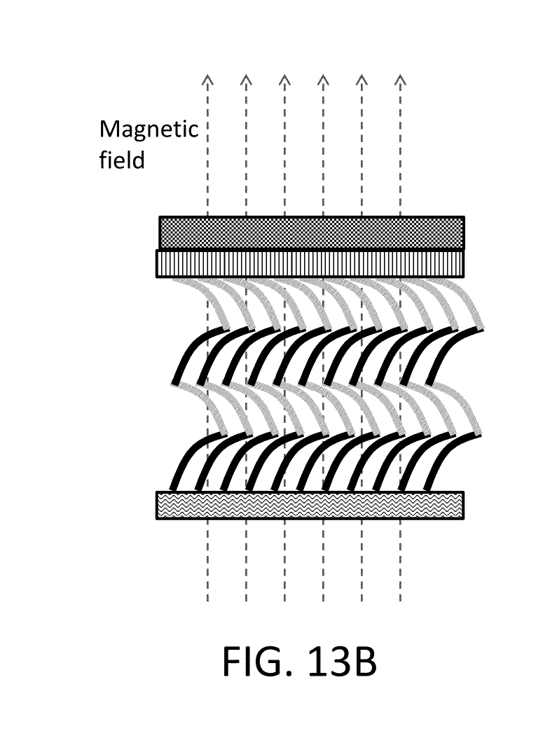

In still yet another embodiment as illustrated in FIG. 13A, an optical filter 1300 may include substrate 1310, nano-rod layers 1320, 1330, 1340, 1350 and dense layer 1370, being arranged in a similar way as the embodiment of FIG. 11A. A magnetic film 1380 is deposited on the top of dense layer 1370. Magnetic film 1380 may be deposited directly on the top of dense layer 1370 using vapor deposition techniques, such as e-beam evaporation, sputtering deposition, or a combination thereof; Otherwise magnetic film 1380 may be a magnetic sheet or a magnetic mesh and may be mounted on the top surface of dense layer 1370 using adhesives, such as epoxy. Magnetic film 1380 may be made of materials such as Ni, Fe, Ni alloy, Fe alloy, and any other magnetic material. Optical filter 1300 including magnetic film 1380 may be placed in a magnetic field, which may be induced by a permanent magnet, a coil magnet or other magnets. By controlling the magnetic field's magnification and polarity, optical filter 1300 may be compressed or stretched, as shown in FIG. 13B. Hence, optical filter 1300 achieves the optical tunability by varying the thicknesses of the nano-feature layers.

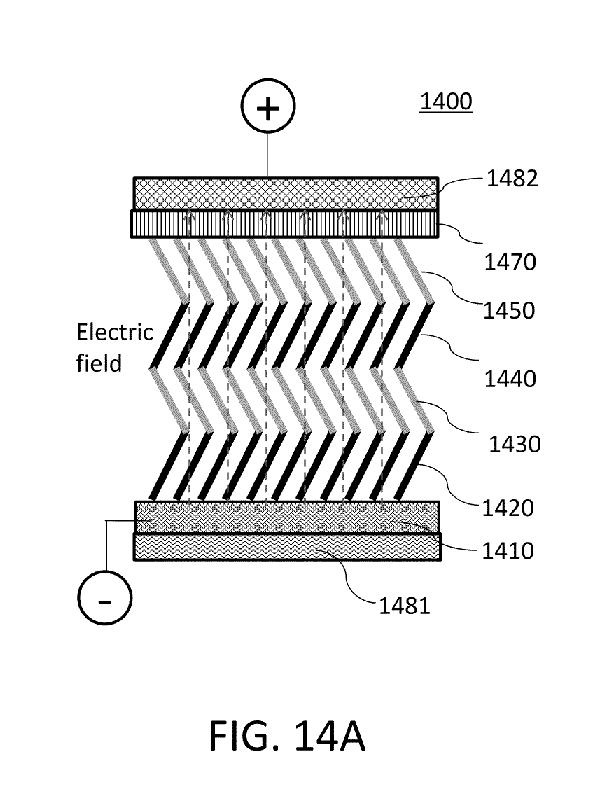

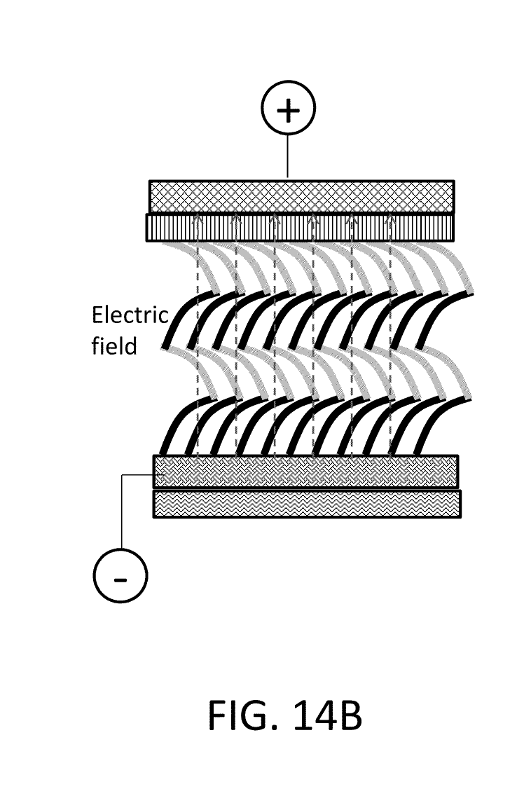

In yet still another embodiment as illustrated in FIG. 14A, an optical filter 1400 may include substrate 1410, nano-rod layers 1420, 1430, 1440, 1450 and dense layer 1470, being arranged in a similar way as the embodiment of FIG. 11A. A first conductive film 1481 is coated on the bottom surface of substrate 1410. First conductive film 1481 may be, but not limited to, a metal film, a transparent conductive oxide film, or an indium tin oxide (ITO) film. A second conductive film 1482 is coated on the top surface of dense layer 1470. Second conductive film 1482 may be, but not limited to, a metal film, a transparent conductive oxide film, or an indium tin oxide (ITO) film. The first and second conductive layers 1481, 1482 may be utilized as two electrodes. By controlling the voltage between first and second conductive layers 1481, 1482, the static electric force between conductive layers 1481, 1482 may compress or stretch optical filter 1400, as shown in FIG. 14B. Hence, optical filter 1400 achieves the optical tunability by varying the thicknesses of the nano-feature layers.

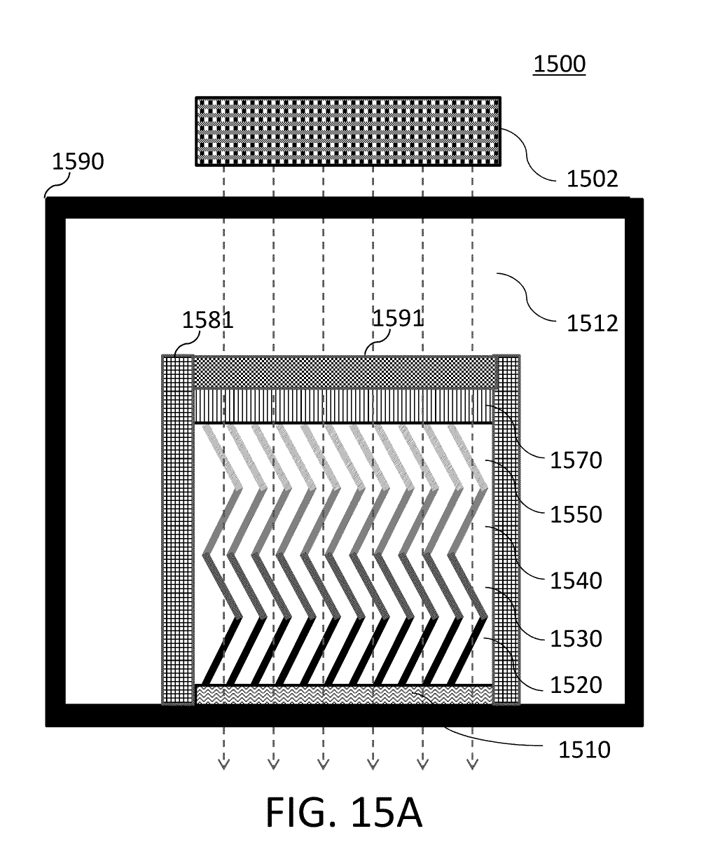

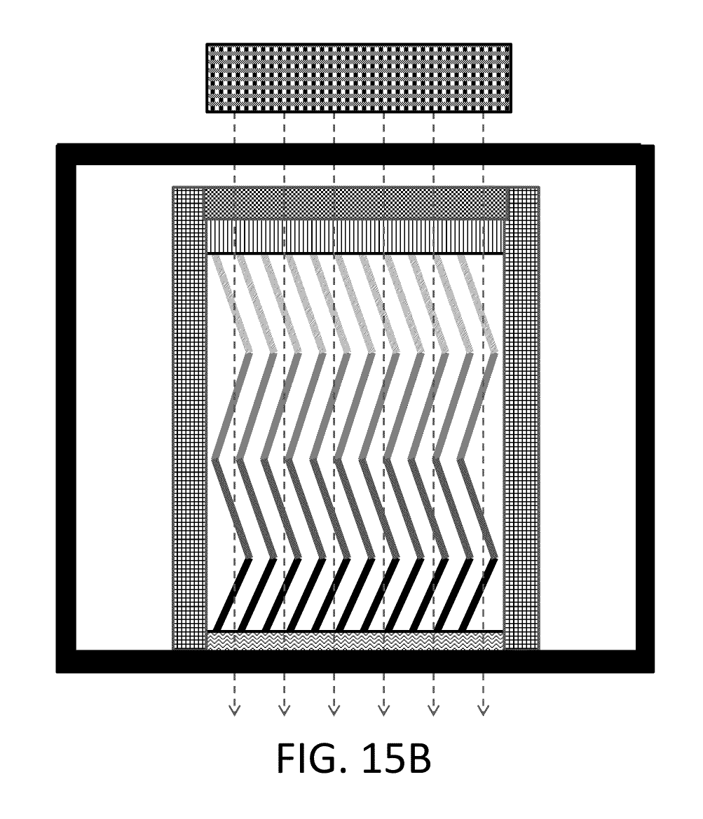

In still yet another embodiment as illustrated in FIG. 15A, an optical filter 1500 may include substrate 1510, nano-rod layers 1520, 1530, 1540, 1550 and dense layer 1570, being arranged in a similar way as the embodiment of FIG. 12A. A dense sealing layer 1591 seals the top surface of dense layer 1570. Dense sealing layer 1591 may be, but not limited to, a thin film by vapor deposition, a plastic sheet, a glass sheet, silicone, or a combination thereof. Sealant 1581 seals the sides of a multilayer stack which comprises substrate 1510, nano-rod layers 1520, 1530, 1540, 1550, dense layer 1570 and dense sealing layer 1591. The whole sealed multilayer stack is disposed inside a sealed container 1590. A buffer 1512 surrounds the whole sealed multilayer stack. The buffer 1512 can be comprised of vacuum, air, gas, liquid, or solid. A source 1502 is located outside or inside the sealed container 1590. The source 1502 may radiate energy towards the buffer 1512. The buffer 1512 such as ice, water, liquid, or gas can absorb energy from the source 1502 generating a volume change in buffer 1512. This volume change in buffer 1512 may cause compression or stretching of nano-rod layers 1520, 1530, 1540, 1550. The source 1502 may be comprised of thermal sources, electro-optical sources, optical pumping sources such as lasers, light-emitting diodes, tungsten lamps, and discharge lamps. By controlling the energy emitted or absorbed by the source 1502, optical filter 1500 may be compressed or stretched, as shown in FIG. 15B. Hence, optical filter 1500 achieves the optical tunability by varying the thicknesses of the nano-feature layers.

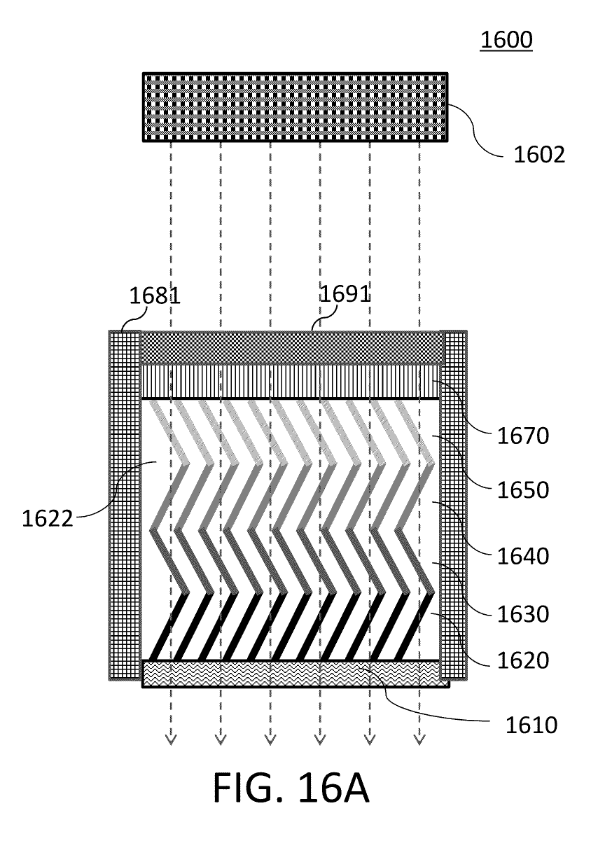

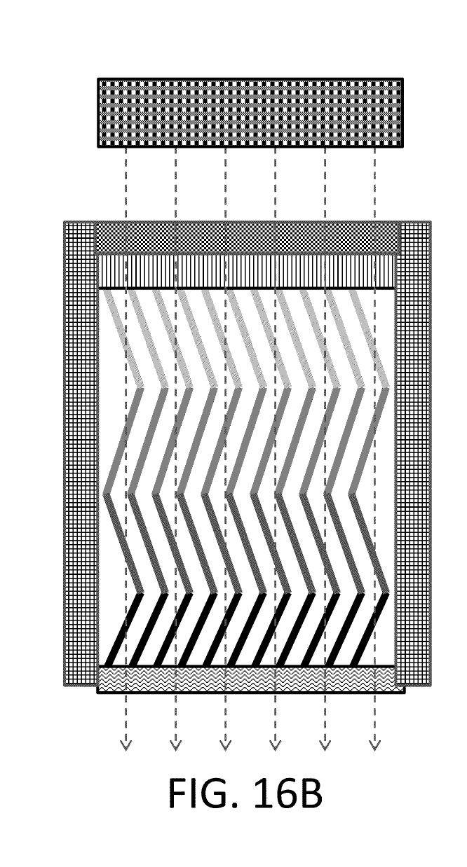

In still yet another embodiment as illustrated in FIG. 16A, an optical filter 1600 may include substrate 1610, nano-rod layers 1620, 1630, 1640, 1650 and dense layer 1670, being arranged in a similar way as the embodiment of FIG. 15A. A dense sealing layer 1691 seals the top surface of dense layer 1670. Dense sealing layer 1691 may be, but not limited to, a thin film by vapor deposition, a plastic sheet, a glass sheet, silicone, or a combination thereof. Sealant 1681 seals the sides of a multilayer stack which comprises substrate 1610, nano-rod layers 1620, 1630, 1640, 1650, dense layer 1570 and dense sealing layer 1691. The source 1602 may radiate energy towards the nano-rod layers 1620, 1630, 1640, 1650. The energy from source 1602 may be absorbed by the space 1622 filled with ice, water, liquid, polymers, positive thermal expansion material, negative thermal expansion material or gas, generating a volume change in space 1622. This volume change in space 1622 may cause compression or stretching of nano-rod layers 1620, 1630, 1640, 1650. The source 1602 may be comprised of thermal sources, electro-optical sources, optical pumping sources such as lasers, light-emitting diodes, tungsten lamps, and discharge lamps. By controlling the energy emitted or absorbed by the source 1602, optical filter 1600 may be compressed or stretched, as shown in FIG. 16B. Hence, optical filter 1600 achieves the optical tunability by varying the thicknesses of the nano-feature layers.

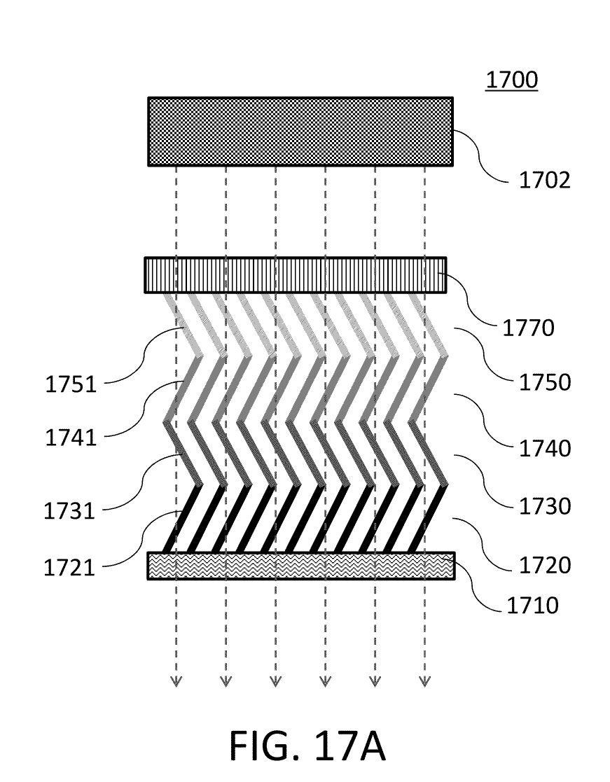

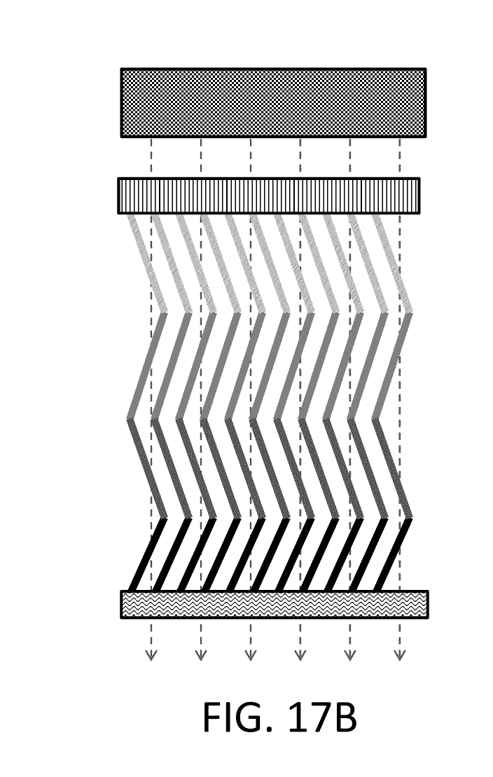

In still yet another embodiment as illustrated in FIG. 17A, an optical filter 1700 may include substrate 1710, nano-rod layers 1720, 1730, 1740, 1750 and dense layer 1770, being arranged in a similar way as the embodiment of FIG. 3A. The source 1702 near optical filter 1700 may radiate energy towards the nano-rod layers 1720, 1730, 1740, 1750. The energy from source 1702 may change the alignment or volume of the nano-rods 1721, 1731, 1741, 1751 1722. Nanorods can be comprised of magnetic material, ferromagnetics, metals, polymers, positive thermal expansion material, or negative thermal expansion material, which may cause compression or stretching of nano-rod layers 1720, 1760, 1760, 1750. The source 1702 may be comprised of magnetic sources, thermal sources, electro-optical sources, optical pumping sources such as lasers, light-emitting diodes, tungsten lamps, and discharge lamps. By controlling the energy emitted or absorbed by the source 1702, optical filter 1700 may be compressed or stretched, as shown in FIG. 17B. Hence, optical filter 1700 achieves the optical tunability by varying the thicknesses of the nano-feature layers.

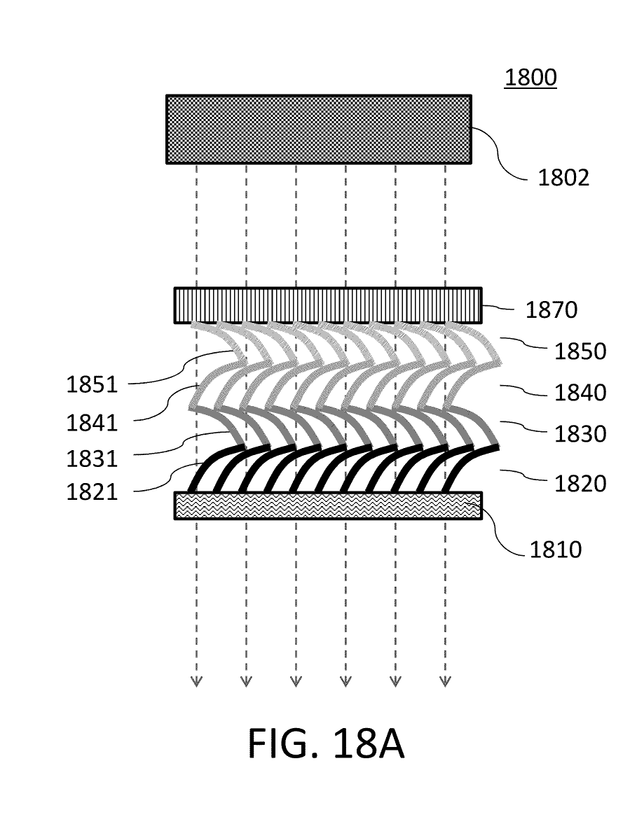

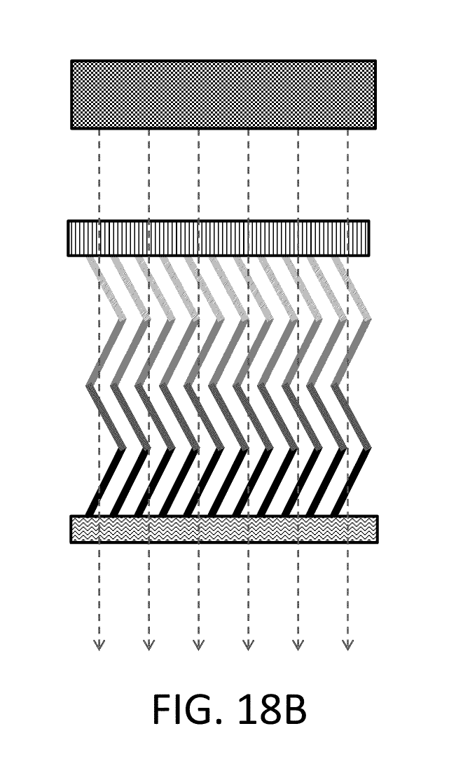

In still yet another embodiment as illustrated in FIG. 18A, an optical filter 1800 may include substrate 1810, nano-rod layers 1820, 1830, 1840, 1850 and dense layer 1870, being arranged in a similar way as the embodiment of FIG. 17A. The source 1802 near optical filter 1800 may radiate energy towards the nano-rod layers 1820, 1830, 1840, 1850. The energy from source 1802 may change the surface attraction or repulsion of nano-rods 1821, 1831, 1841, 1851 1822. Nano-rods 1821, 1831, 1841, 1851 1822 can be comprised of transparent materials with surface hydroxyl groups or water, materials with surfactants, electrostatic attraction or repulsion, or materials with any adsorbed molecule on the surface. The energy from source 1802 can attract or release the surface molecules from nanorods 1821, 1831, 1841, 1851. The change in the surface attraction or repulsion may cause compression or stretching of nano-rod layers 1820, 1860, 1860, 1850. The source 1802 may be comprised of magnetic sources, thermal sources, electro-optical sources, optical pumping sources such as lasers, light-emitting diodes, tungsten lamps, and discharge lamps. By controlling the energy emitted or absorbed by the source 1802, optical filter 1800 may be compressed or stretched, as shown in FIG. 18B. Hence, optical filter 1800 achieves the optical tunability by varying the thicknesses of the nano-feature layers.

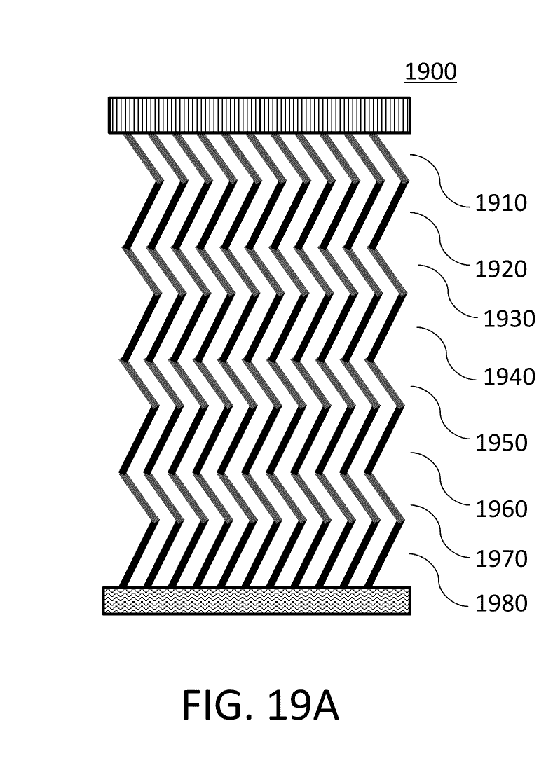

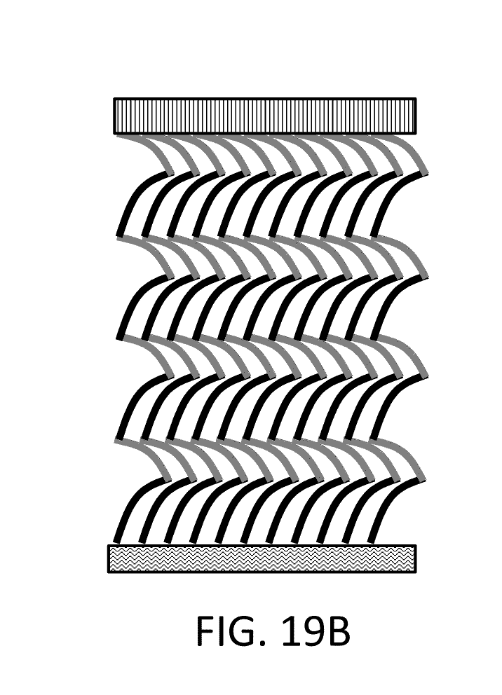

In yet still another embodiment as illustrated in FIG. 19A, an optical filter 1900 may include nano-rod layers 1910, 1920, 1930, 1940, 1950, 1960, 1970, and 1980. Each layer of nano-rod layers 1910, 1930, 1950, 1970 contains a layer of nano-rods and has a first effective refractive index. Each layer of nano-rod layers 1920, 1940, 1960, 1980 contains a layer of nano-rods and has a second effective refractive index that is different from the first effective refractive index. The nano-rod layers with two different effective refractive indices are arranged as alternating layers as shown in FIG. 19A. Except the top and bottom layer, each nano-rod layer is sandwiched by the immediate upper and lower nano-rod layers; and these two immediate layers have effective refractive index different than the sandwiched layer. Thus, the optical filter 1900 has a periodic variation in the effective refractive index through the layers. Each layer boundary causes some reflection of a light due to the index difference. Preferably, the physical thicknesses of the layers are chosen so that the optical thickness of the layers is substantially close to a quarter of a targeting light wavelength. The reflections resulted from the layer boundaries combine with constructive interference, and the layers act as a highly efficient reflector at the targeting light wavelength. The nano-rods in nano-rod layers 1910, 1920, 1930, 1940, 1950, 1960, 1970, 1980 are flexible nano-features that may achieve a large structural deformation. Therefore, the layers may change the optical thicknesses by bending, deforming, compressing, or stretching the nano-features reversibly. For example, as shown in FIG. 19B, the nano-rods are compressed and the optical thickness of the layers is changed accordingly. The resulting optical thickness is substantially close to a quarter of a new light wavelength; the optical filter 1900 may be adjusted to be a highly efficient reflector at a new targeting wavelength. By adjusting the thickness, the optical filter 1900 works as a highly efficient adjustable reflector to be optimized at a wide range of targeting wavelengths. Hence, optical filter 1900 achieves the optical tunability by varying the thicknesses of the nano-feature layers.

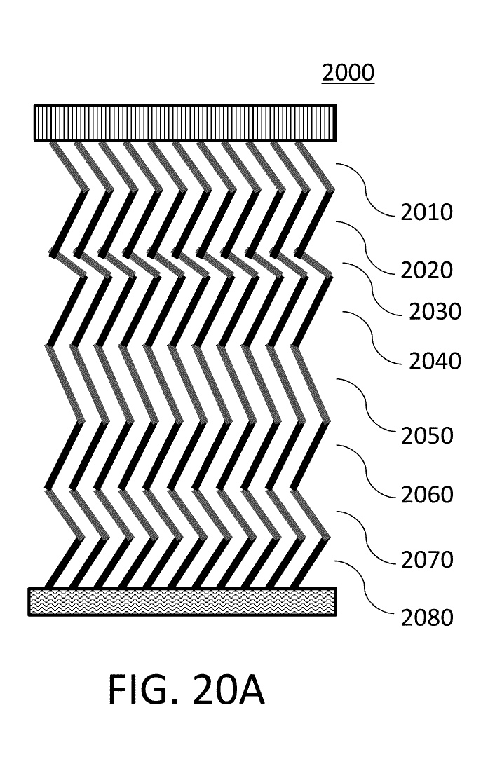

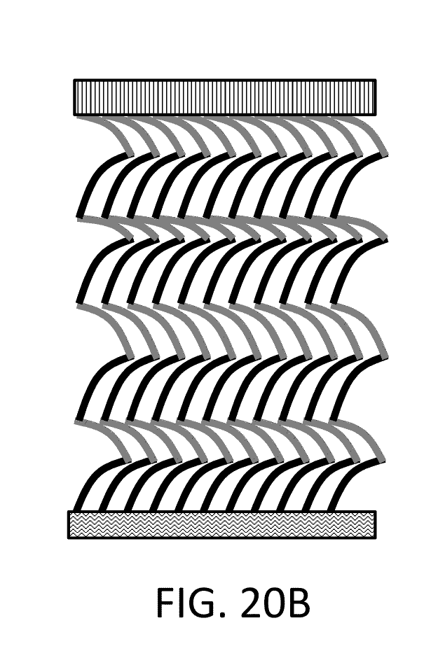

In still yet another embodiment as illustrated in FIG. 20A, an optical filter 2000 may include nano-rod layers 2010, 2020, 2030, 2040, 2050, 2060, 2070, and 2080. Preferably, the physical thicknesses of the layers are chosen so that the optical thicknesses of the layers cause the layers to work as a short or long wave pass edge filters. For example, the thicknesses of the layers may be optimized to minimize transmission above a given transitional wavelength and maximize transmission below it. The nano-rods in nano-rod layers 2010, 2020, 2030, 2040, 2050, 2060, 2070, and 2080 are flexible nano-features that may achieve a large structural deformation. Therefore, the layers may change the optical thicknesses by bending, deforming, compressing, or stretching the nano-features reversibly. For example, as shown in FIG. 20B, the nano-rods are compressed and the optical thicknesses of the layers are changed accordingly. The resulting optical filter 2000 may be a short wave pass edge filter with a different transitional wavelength. Hence, optical filter 2000 achieves the optical tunability by varying the thicknesses of the nano-feature layers.

In some embodiments, the nano-features have different elasticities. For example, one nanorod layer may be deformed up to 50% while another nanorod layer may be deformd up to 30%. In some embodiments, the nanorod layers may be, but not limited to, the same material with different porosities, the same material with the same porosity, different materials with the same porosity, or different materials with different porosities.

While the principles of the invention have been described herein, it is to be understood by those skilled in the art that this description is made only by way of example and not as a limitation as to the scope of the invention. For example, any mechanisms that may achieve the controllable thickness change of the optical filter may be utilized in the optical filter to enable the spectral tunability of the optical filter and are understood to be within the scope of the invention. Reference numerals corresponding to the embodiments described herein may be provided in the following claims as a means of convenient reference to the examples of the claimed subject matter shown in the drawings. It is to be understood however, that the reference numerals are not intended to limit the scope of the claims. Other embodiments are contemplated within the scope of the present invention in addition to the exemplary embodiments shown and described herein. Modifications and substitutions by one of ordinary skill in the art are considered to be within the scope of the present invention, which is not to be limited except by the recitations of the following claims.

What is claimed is:

1. An optical filter comprising:
a substrate; and
a plurality of at least four optical thin film layers disposed on top of the substrate, each of the optical thin film layers having an effective refractive index different from effective refractive indices of the immediate upper and lower optical thin film layers, at least one of the optical thin film layers being a thickness tunable nano-feature layer, the nano-feature layer comprising a plurality of flexible nano-features, at least one of the optical thin film layers being a dense layer.

2. The optical filter of claim 1, wherein the top layer of the plurality of the optical thin film layers is a dense layer.

3. The optical filter of claim 1, wherein the plurality of optical thin film layers is a plurality of optical thin film pairs, each pair of the optical thin film pairs comprising a low-index optical thin film layer and a high-index optical thin film layer.

4. The optical filter of claim 3, wherein the high-index optical thin film layer of each pair of the optical thin film pairs has an effective refractive index higher than an effective refractive index of the low-index optical thin film layer of the same pair.

5. The optical filter of claim 1, wherein the optical filter has a targeting wavelength and each of the optical thin film layers has an optical thickness substantially close to a quarter of the targeting wavelength.

6. The optical filter of claim 1, wherein the flexible nano-features comprises at least one structure selected from the group consisting of nano-rods, nano-tubes, nano-belts, nano-springs, nano-wires, nano-columns, nano-spirals, and zigzag-shaped chains of nano-rods.

7. The optical filter of claim 1, wherein the flexible nano-features are core-shell nano-features.

8. The optical filter of claim 1, wherein the flexible nano-features comprises at least one material selected from the group consisting of SiO₂, SiO, TiO₂, MgF₂, Al₂O₃, BaF₂, CaF₂, Si, Si₃N₄, GaN, AlN, InN, AlGaN, GaInN, ITO, ZnO, GaAs, GaP, Ge, ZnSe, PMMA, and acrylic glass.

9. The optical filter of claim 1, wherein the optical thin film layers comprises at least one material selected from the group consisting of glass, SiO₂, SiO, TiO₂, MgF₂, Al₂O₃, BaF₂, CaF₂, Si, Si₃N₄, GaN, AlN, InN, AlGaN, GaInN, ITO, ZnO, GaAs, GaP, Ge, ZnSe, PMMA, and acrylic glass.

10. The optical filter of claim 1, wherein the substrate comprises at least one material selected from the group consisting of glass, SiO₂, SiO, TiO₂, MgF₂, Al₂O₃, BaF₂, CaF₂, Si, Si₃N₄, GaN, AlN, InN, AlGaN, GaInN, ITO, ZnO, GaAs, GaP, Ge, ZnSe, PMMA, and acrylic glass.

11. The optical filter of claim 1, wherein the optical filter has a thickness and the optical filter further comprises a means for changing the thickness of the optical filter.

12. The optical filter of claim 11, wherein the means for changing the thickness of the optical filter comprises at least one piezoelectric actuator, mechanical piston, MEMS actuator, electrical motor, pneumatic actuator, hydraulic actuator, linear actuator, comb-drives capacitive actuator, amplified piezoelectric actuator, thermal bimorph, micromirror device, electroactive polymer, electromagnetic actuator, magnet, magnetic mesh,magnetic film, conductive flim, metal mesh, metal film, transparent electrode, transparent semiconductor film, transparent conductive oxide film, indium tin oxide film, laser optical pump, light-emitting diode optical pump, tungsten lamp optical pump, discharge lamp optical pump, heat pump, thermal cooling device, or pressure port.

13. The optical filter of claim 1, wherein the flexible nano-features have a spacing-to-width ratio larger than 1:2.

14. The optical filter of claim 1, wherein the flexible nano-features have a spacing-to-width ratio larger than 1:1.

15. The optical filter of claim 1, wherein the flexible nano-features have a spacing-to-width ratio larger than 2:1.

16. The optical filter of claim 1, wherein the flexible nano-features have a length-to-width ratio larger than 3:1.

17. The optical filter of claim 1, wherein the flexible nano-features have a length-to-width ratio larger than 6:1.

18. The optical filter of claim 1, wherein the flexible nano-features have a length-to-width ratio larger than 10:1.

19. The optical filter of claim 1, wherein the nano-feature layer has an area larger than 50×50 μm².

20. The optical filter of claim 1, wherein the nano-feature layer has a porosity of at least 50%.

21. The optical filter of claim 1, wherein the nano-feature layer has a porosity of at least 70%.

22. The optical filter of claim 1, wherein the nano-feature layer has a porosity of at least 90%.

23. The optical filter of claim 1, wherein the nano-feature layer has a space and the space is filled with at least one material selected from the group consisting of air, gas, liquid, water, optical fluid, transparent fluid, opaque fluid, semi-transparent fluid, diffusive fluid, organic solution, elastic host material, polymer resin, gel, and silicone.

24. The optical filter of claim 1, wherein the nano-feature layer has a space and the space is in vacuum.

25. An optical filter comprising:
a substrate;
a plurality of first optical thin film layers disposed on top of the substrate,
a thickness tunable layer disposed on top of the first optical thin film layers, the thickness tunable layer comprising at least one first nano-feature layer, the first nano-feature layer comprising a plurality of flexible nano-features; and
a plurality of second optical thin film layers disposed on the thickness tunable layer, at least one of the second optical thin film layers being a dense layer.

26. The optical filter of claim 25, wherein the top layer of the plurality of the second optical thin film layers is a dense layer.

27. The optical filter of claim 25, wherein the thickness tunable layer further comprising a second nano-feature layer disposed on top of the first nano-feature layer and the second nano-feature layer comprising a plurality of flexible nano-features.

28. The optical filter of claim 25, wherein the optical filter has a targeting wavelength and each of the first and second optical thin film layers has an optical thickness substantially close to a quarter of the targeting wavelength.

29. The optical filter of claim 28, wherein the thickness tunable layer further comprising a third nano-feature layer disposed on top of the second nano-feature layer and the third nano-feature layer comprising a plurality of flexible nano-features.

30. The optical filter of claim 25, wherein the thickness tunable layer further comprising:
a first dense layer disposed on top of the first nano-feature layer; and
a second nano-feature layer disposed on top of the first dense layer and the second nano-feature layer comprising a plurality of flexible nano-features.

31. The optical filter of claim 30, wherein the thickness tunable layer further comprising:
a second dense layer disposed on top of the second nano-feature layer; and
a third nano-feature layer disposed on top of the second dense layer and the third nano-feature layer comprising a plurality of flexible nano-features.

32. The optical filter of claim 25, wherein the plurality of the first optical thin film layers is a plurality of optical thin film pairs, each pair of the optical thin film pairs comprising a low-index optical thin film layer and a high-index optical thin film layer, the high-index optical thin film layer of each pair of the optical thin film pairs having an effective refractive index higher than an effective refractive index of the low-index optical thin film layer of the same pair.

33. The optical filter of claim 25 wherein at least one of the first optical thin film layers has a reflective surface.

34. The optical filter of claim 25, wherein at least one of the second optical thin film layers has a reflective surface.

35. The optical filter of claim 25, wherein the flexible nano-features comprises at least one structure selected from the group consisting of nano-rods, nano-tubes, nano-belts, nano-springs, nano-wires, nano-columns, nano-spirals, and zigzag-shaped chains of nano-rods.

36. The optical filter of claim 25, wherein the flexible nano-features are core-shell nano-features.

37. The optical filter of claim 25, wherein the flexible nano-features comprises at least one material selected from the group consisting of SiO₂, SiO, TiO₂, MgF₂, Al₂O₃, BaF₂, CaF₂, Si, Si₃N₄, GaN, AlN, InN, AlGaN, GaInN, ITO, ZnO, GaAs, GaP, Ge, ZnSe, PMMA, and acrylic glass.

38. The optical filter of claim 25, wherein the first and second optical thin film layers comprises at least one material selected from the group consisting of glass, SiO₂, SiO, TiO₂, MgF₂, Al₂O₃, BaF₂, CaF₂, Si, Si₃N₄, GaN, AlN, InN, AlGaN, GaInN, ITO, ZnO, GaAs, GaP, Ge, ZnSe, PMMA, and acrylic glass.

39. The optical filter of claim 25, wherein the substrate comprises at least one material selected from the group consisting of glass, SiO₂, SiO, TiO₂, MgF₂, Al₂O₃, BaF₂, CaF₂, Si, Si₃N₄, GaN, AlN, InN, AlGaN, GaInN, ITO, ZnO, GaAs, GaP, Ge, ZnSe, PMMA, and acrylic glass.

40. The optical filter of claim 25, wherein the optical filter has a thickness and the optical filter further comprises a means for changing the thickness of the optical filter.

41. The optical filter of claim 40, wherein the means for changing the thickness of the optical filter comprises at least one piezoelectric actuator, mechanical piston, MEMS actuator, electrical motor, pneumatic actuator, hydraulic actuator, linear actuator, comb-drives capacitive actuator, amplified piezoelectric actuator, thermal bimorph, micromirror device, electroactive polymer, electromagnetic actuator, magnet, magnetic mesh,magnetic film, conductive flim, metal mesh, metal film, transparent electrode, transparent semiconductor film, transparent conductive oxide film, indium tin oxide film, laser optical pump, light-emitting diode optical pump, tungsten lamp optical pump, discharge lamp optical pump, heat pump, thermal cooling device, or pressure port.

42. The optical filter of claim 25, wherein the flexible nano-features have a spacing-to-width ratio larger than 1:2.

43. The optical filter of claim 25, wherein the flexible nano-features have a spacing-to-width ratio larger than 1:1.

44. The optical filter of claim 25, wherein the flexible nano-features have a spacing-to-width ratio larger than 2:1.

45. The optical filter of claim 25, wherein the flexible nano-features have a length-to-width ratio larger than 3:1.

46. The optical filter of claim 25, wherein the flexible nano-features have a length-to-width ratio larger than 6:1.

47. The optical filter of claim 25, wherein the flexible nano-features have a length-to-width ratio larger than 10:1.

48. The optical filter of claim 25, wherein the nano-feature layer has an area larger than 50×50 μm².

49. The optical filter of claim 25, wherein the nano-feature layer has a porosity of at least 50%.

50. The optical filter of claim 25, wherein the nano-feature layer has a porosity of at least 70%.

51. The optical filter of claim 25, wherein the nano-feature layer has a porosity of at least 90%.

52. An optical filter comprising:
a substrate;
a plurality of first optical thin film pairs disposed on top of the substrate, each pair of the first optical thin film pairs comprising a low-index optical thin film layer and a high-index optical thin film layer, the high-index optical thin film layer of each pair of the first optical thin film pairs being disposed on top of the low-index optical thin film layer of the same pair, the high-index optical thin film layer of each pair of the first optical thin film pairs having an effective refractive index higher than an effective refractive index of the low-index optical thin film layer of the same pair;
a thickness tunable layer disposed on top of the first optical thin film layers, the thickness tunable layer comprising at least one first nano-feature layer, the first nano-feature layer comprising a plurality of flexible nano-features, the flexible nano-features having a spacing-to-width ratio larger than 2:1; the flexible nano-features having a length-to-width ratio larger than 10:1; and
a plurality of second optical thin film pairs disposed on top of the thickness tunable layer, each pair of the first optical thin film pairs comprising a low-index optical thin film layer and a high-index optical thin film layer, the low-index optical thin film layer of each pair of the second optical thin film pairs being disposed on top of the high-index optical thin film layer of the same pair, the high-index optical thin film layer of each pair of the second optical thin film pairs having an effective refractive index higher than an effective refractive index of the low-index optical thin film layer of the same pair.

53. The optical filter of claim 52, further comprising a dense layer disposed on top of the plurality of the second optical thin film layers.

54. The optical filter of claim 52, wherein the flexible nano-features comprises at least one structure selected from the group consisting of nano-rods, nano-tubes, nano-belts, nano-springs, nano-wires, nano-columns, nano-spirals, and zigzag-shaped chains of nano-rods.

55. The optical filter of claim 52, wherein the optical filter has a thickness and the optical filter further comprises a means for changing the thickness of the optical filter.
